(19) United States
(12) Patent Application Publication
(10) Pub. No.: US 2026/0020565 A1
(43) Pub. Date: Jan. 22, 2026

(54) PYMETROZINE AQUEOUS COMPOSITIONS

(71) Applicant: ADAMA MAKHTESHIM LTD., Beer Sheva (IL)

(72) Inventors: Ying XU, Jiangsu (CN); Yohai DAYAGI, Kibbutz Kramim (IL); Lin CHEN, Jingzhou City (CN)

(73) Assignee: ADAMA MAKHTESHIM LTD., Beer Sheva (IL)

(21) Appl. No.: 18/993,483

(22) PCT Filed: Jul. 10, 2023
(86) PCT No.: PCT/IL2023/050717

§ 371 Date: Jan. 10, 2025

(30) Foreign Application Priority Data
Jul. 11, 2022 (CN) 202210809404.X

(51) Int. Cl. A01N 43/707; A01N 25/04; A01N 25/22; A01N 43/40; A01P 7/04

(52) U.S. Cl. CPC A01N 43/707; A01N 25/04; A01N 25/22; A01N 43/40; A01P 7/04

(57) ABSTRACT

The present invention relates to flowable aqueous compositions of a combination of pymetrozine and pymetrozine compatibilizing agent (PCA) in water, wherein the pymetrozine compatibilizing agent is selected from the compounds defined in the description. The compositions are flowable, pourable and have low viscosity even at high load such as in a concentrated SC. The compositions are suitable for inclusion of a further insecticidal compound which are shown to be characterized by faster insecticidal efficacy in a single day after application. The compositions are also characterized by an improved Pymetrozine stability reflected in a long half-life and reduced degradation during storage as packaged compositions.

Throughout this application various publications are referenced. The disclosures of these documents in their entireties are hereby incorporated by reference into this application to more fully describe the state of the art to which this invention pertains.

### FIELD

The present invention relates to pymetrozine compatibilizing agents, ingredients or additives that enable improved water-based compositions comprising pymetrozine. The invention further relates to methods for preparing and using said composition.

### INTRODUCTION

Pymetrozine, chemical name 6-methyl-4-[(E)-pyridin-3-ylmethylideneamino]-4,5-dihydro-1,2,4-triazin-3(2H)-one is an insecticide which is well known for controlling different insects.

Pymetrozine, when formulated, in presence of water, tends to absorb water leading to increasingly unfavorable composition characteristics, including, though not limited to compositions wherein the flowability of the composition is reduced and/or the viscosity of the composition increases such that, inter alia, the ability to manufacture and/or use the desired water based Pymetrozine composition is severely compromised and challenging.

High load pesticide compositions generally present formulation challenges, and notably so with Pymetrozine water-based compositions. The impact of absorption of water and consequent reduction in the flowability and/or increase in viscosity of the compositions mentioned above is more pronounced and its effects are more harmful to the composition when the concentration of the pymetrozine in the composition is increased and this is especially evident at concentrations exceeding 20% w/w by weight based on the total weight of the composition.

Inventors also note some of the further challenges to formulating water based Pymetrozine compositions. For example, Pymetrozine is known to lack humidity stability and the anhydrate form is known to spontaneously convert to its hydrate form at high relative humidity. This conversion during formulation of aqueous compositions, further exasperates the formulation challenges.

It is also noted that pymetrozine is photolabile and it has even been reported that the rate of photodegradation of pymetrozine in water may have a half-life of only 9 hours. See, Ximei Liang, et. al., “Pivotal role of water molecules in the photodegradation of pymetrozine: New insights for developing green pesticides, Journal of Hazardous Materials Volume 423, Part B, 2022, 127197, ISSN 0304-3894, https://doi.org/10.1016/j.jhazmat.2021.127197. This characteristic of pymetrozine further complicates the formulation challenges associated with water-based pymetrozine compositions intended for application in an agricultural setting.

Inventors further note that reportedly, increasing the half-life of pymetrozine in water continues to be a challenge to the utilization of aqueous (water-based), formulations and compositions comprising pymetrozine.

It has also been reported that aqueous pymetrozine, particularly when dissolved is stable at particular ranges of pH. Particulate solid suspensions of pymetrozine should not display sensitivity to this issue, although given that some additives can increase the pymetrozine aqueous solubility (even a little), maintaining pymetrozine stability over a wide range of acidity/alkalinity would clearly be an advantageous precaution.

According to the available studies, photolysis may also contribute to the degradation of pymetrozine in pesticide applications exposed to sunlight, e.g., after application in an agricultural setting.

see, “Conclusion on the peer review of the pesticide risk assessment of the active substance pymetrozine by the European Food Safety Authority, found at, https://efsa.onlinelibrary.wiley.com/doi/pdf/10.2903/j.efsa.2014.3817 #:-:text=In %20s terile %20aqueous %20solution %20pymetrozine,are %20stable %20 to %20further %20h ydrolysis.

There is an on-going need to develop improved aqueous (water-based), formulations and compositions comprising pymetrozine and particularly having high pymetrozine content.

It would be desirable to be able to formulate acceptable aqueous pymetrozine compositions with stable qualities including, chemical as well as viscosity, pourability etc. comprising a combination with additional pesticidal compounds such as flonicamid in a single suspension concentrate SC form, having efficacy comparable to that of tank-mixed combinations of individual compositions.

There is an on-going need to increase/improve the speed at which an insecticide has an effect on the mortality of a target insect pest. Two insecticidal compositions having similar efficacy may be distinguished by how quickly the effect is established. An insecticide that improves the mortality rate a single day after application will be considered improved even if the overall efficacy measured in mortality is the same as another which displays a lower mortality of the target insect pests within a day after application.

Additionally, there is a continuing challenge to provide aqueous (water-based) pymetrozine compositions particularly in solid suspension form wherein the polymorphic/solvate form of Pymetrozine is stable and recrystallization, or form conversion is reduced especially when the suspension includes a further pesticide such as Flonicamid in the same composition.

### SUMMARY OF THE INVENTION

The present invention provides a flowable water-based composition comprising (1) an amount of pymetrozine, (2) an amount of a pymetrozine compatibilizing agent (PCA) and (3) water.

The pymetrozine compatibilizing agent (PCA), is selected from one or more of the following structures,
a. phosphoric acid diester, of the following structure,

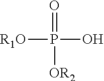

wherein R₁ and R₂ are each independently alkyl or aryl, and R₁ and R₂ are either the same or different. The alkyl groups being typically C₆ or higher;
b. phosphoric acid mono ester, of the following structure,

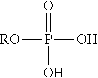

wherein R is alkyl or aryl, the alkyl group being typically C₆ or higher;
c. Sulfuric acid mono ester, of the following structure,

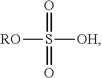

wherein R is alkyl or aryl, the alkyl group being typically C₆ or higher;
d. Sulfonic acid, of the following structure,

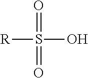

wherein R is alkyl or aryl, the alkyl group being typically C₆ or higher.

The pymetrozine compatibilizing agent (PCA), is often typically chosen from, monoalkyl phosphate; dialkyl phosphate; a dialkyl ester of sulfonated succinic acid or salt thereof and any and all combinations thereof.

The present invention provides combinations of pymetrozine and at least one pymetrozine compatibilizing agent (PCA)selected from one or more of, monoalkyl phosphate; dialkyl phosphate; a dialkyl ester of sulfonated succinic acid or salt thereof and any and all combinations thereof which improves the flowability and reduces the viscosity characteristics of water-based pymetrozine compositions comprising the combination.

The pymetrozine compatibilizing agent (PCA), is typically a surface active material exemplified by, though not limited to, compounds selected from
Phosphoric acid, n-octyl, n-decyl esters (C₈, C₁₀)
Iso-tridecyl phosphate (C₁₃);
Di-iso-octyl phosphate (C₈, C₈)
Di-decyl phosphate (C₁₀, C₁₀)
Dioctyl sodium sulfosuccinate (acidified); and
combinations thereof. The PCA is preferably employed in its acid form.

In particular it is noted that while ethoxylated phosphate esters are apparently known in compositions as co-formulants however, the inventive alkylated phosphate esters exemplified as having alkyl groups of six carbon atoms (C₆) or more, are almost unheard of in agrochemical compositions, if at all.

The flowable water-based pymetrozine compositions of the invention display surprisingly advantageous characteristics even when the pymetrozine content is significantly above 50% w/w by weight of the composition.

Useful water-based pymetrozine compositions containing as much as 55% by weight of the composition are now enabled by the combination of pymetrozine and one or more pymetrozine compatibilizing agent, as herein disclosed.

Inventors note, that without wishing to be bound to any theory, it is conceivable that the mechanism by which the pymetrozine compatibilizing agent improves the flowability and/or reduces the viscosity characteristics of water-based pymetrozine compositions may concomitantly also improve the photostability of the pymetrozine and/or reduce the known rate of photodegradation in water, evidenced by a significantly longer half-life of the pymetrozine in the compositions of the invention.

The half-life of pymetrozine in the flowable water-based pymetrozine compositions of the invention of the invention exposed to sunlight is at least 24 hours, typically well in excess of 96 hours, notedly greater than 1 week.

However, inventors emphasize that this additional aspect of photostability is not intended in any way to limit the scope of the inventive pymetrozine compatibilizing agents that are intended to improve both the ease of manufacture and/or the physical characteristics of the aqueous pymetrozine aqueous compositions,

The attribute of chemical stability to degradation could be a basis for a choice of one pymetrozine compatibilizing agent over another when both equally improve ease the preparation or the physical characteristics of water-based pymetrozine compositions without in anyway characterizing one as less within the scope of this invention as the other. In either case, improvements in this aspect are alternatively the result of additional agriculturally acceptable additives included in the compositions comprising the inventive combinations as described below.

Inventors note, that without wishing to be bound to any theory, that a significant number of ingredients suggested in this disclosure are known to inhibit crystallization or recrystallization, notably exemplified by PVP/Vinylpyrrolidone (homo) polymers Sokalan® K30 P Sokalan® K15 P. To the extent (if any), that the unfavorable characteristics of previously known water-based compositions of pymetrozine were at least in small part mediated by conversion, or interconversion of pymetrozine polymorph, solvate, anhydrate, dissolved, forms, it is conceivable that additional advantages including further improvements in viscosity and flowability characteristics especially over a period of storage are found to be achievable by the addition of this class of additive in addition to the disclosed pymetrozine compatibilizing agents as exemplified below.

However, inventors emphasize that this aspect of crystallization inhibition is not intended in any way to limit the scope of the inventive pymetrozine compatibilizing agents that improve the physical characteristics of the aqueous pymetrozine aqueous compositions, but this attribute could be a basis for a choice of one pymetrozine compatibilizing agent over another which is equally useful when both improve the physical characteristics of water-based pymetrozine compositions without in anyway characterizing one as less, within the scope of this invention, than the other.

Thus, inventors contemplate the usefulness of including selected agriculturally acceptable additives together with the disclosed combination of pymetrozine and pymetrozine compatibilizing agents, each being chosen for their individual additional attributes over and above the compatibilizing characteristics of the inventive compatibilizing agents. These may include the various stabilizing attributes alluded to above.

The following products have been found to be useful pymetrozine compatibilizing agents of particular note:
Phosphoric acid, n-octyl, n-decyl esters (C₈, C₁₀)
Iso-tridecyl phosphate (C₁₃);
Di-iso-octyl phosphate (C₈, C₈)
Di-decyl phosphate (C₁₀, C₁₀)
Dioctyl sodium sulfosuccinate (acidified); and
combinations thereof. There is a preference for PCA compounds in their acid form.

Phosphoric mono- and di-esters of long-chain branched or linear alcohols having 6 to 22 carbon atoms (C₆-C₂₂ alkyl) and the salts thereof, alkylsulfates having 6 to 22 carbon atoms (C₆-C₂₂ alkyl), alkane sulfonates having 6 to 22 carbon atoms (C₆-C₂₂ alkyl), or olefin sulfonates have indications of being useful.

In some embodiments, the composition is an aqueous suspension of pymetrozine and pymetrozine compatibilizing agent in a liquid water-based carrier.

In some embodiments, the aqueous suspension is suspension concentrate.

In some embodiments, the present invention provides a suspension concentrate comprising (1) an amount of pymetrozine, (2) an amount of pymetrozine compatibilizing agent and (3) water. The pymetrozine compatibilizing agent is often a surfactant selected from one or more of, monoalkyl phosphate; dialkyl phosphate; a dialkyl ester of sulfonated succinic acid or salt thereof and any and all combinations thereof.

In some embodiments, the pymetrozine compatibilizing agent is a surfactant which is phosphoric acid n-octyl, n-decyl ester.

An interesting compound is Phosphoric acid, mixed decyl and octyl esters, compounds with diethanolamine (CAS 68425-57-0).

In some embodiments, the alkyl groups of the mono- or di-alkyl phosphate comprise between 8 and 10 carbon atoms and sometimes specifically 8 and 10 carbon atoms.

In some embodiments, as alluded to above, the phosphate ester is mono ester, di ester and combination thereof. Of note is the Phosphoric acid, n-octyl, n-decyl esters C₈, C₁₀) available as Crodafos™ 810A, often depicted by the following structure,

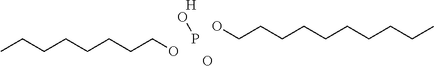

although descriptions or illustrations depicting the compound as Decan-1-ol;octan-1-ol;phosphoric acid made up of the components (1-Octanol), (Phosphoric acid) and (1-Decanol), do not depart from the scope of the term Phosphoric acid, n-octyl, n-decyl esters C₈, C₁₀).

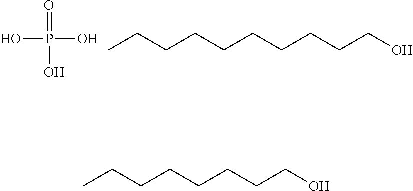

The present invention also provides compositions comprising
(1) an amount of pymetrozine,
(2) an amount of at least one pymetrozine compatibilizing agent, such as, surfactant selected from one or more of, monoalkyl phosphate; dialkyl phosphate; a dialkyl ester of sulfonated succinic acid or salt thereof and any and all combinations thereof and
(3) water,
and processes for preparing the compositions.

A process for preparing the pymetrozine composition of the invention comprises,
(1) preparing a water solution of at least one pymetrozine compatibilizing agent, such as a surfactant as exemplified above, to obtain solution A,
(2) adding pymetrozine to solution A to form suspension B, and
(3) milling the obtained suspension to provide the pymetrozine composition.

As alluded to earlier, the pymetrozine compatibilizing agents are commonly surfactants selected from monoalkyl phosphate; dialkyl phosphate; a dialkyl ester of sulfonated succinic acid or salt thereof and any and all combinations thereof.

In several embodiments the present invention provides a suspension concentrate comprising from about 10% to about 55% w/w pymetrozine based on the total weight of the composition. As discussed, the term “about” is used herein to include a suspension concentrate comprising from 10%±10% to 55%±10% w/w pymetrozine based on the total weight of the composition.

In several embodiments the present invention provides a suspension concentrate comprising,
(1) 30%±10% w/w pymetrozine based on the total weight of the composition,
(2) 1.5%±10% w/w phosphoric acid di-alkyl (C₆ or more), ester as pymetrozine compatibilizing agent, based on the total weight of the combination and
(3) 40%±10%, water.

The phosphoric acid di-alkyl ester having alkyl groups comprising six or more carbon atoms, can be an octyl/decyl phosphate.

In some embodiments, the composition further comprises additional pesticidal active ingredient(s) (pesticide).

In some embodiments, the additional pesticide includes an insecticide

In some embodiments, the insecticide is flonicamid pyridaben, Imicyafos, Thiacloprid, Ethiprole, Ethion, Thiamethoxam, imidacloprid, fenoxycarb, mobucin, nitenpyram, abamectin, buprofezin, pyriproxyfen, etofenprox or acetamiprid, of note is the combinations of flonicamid and the inventive pymetrozine compositions herein disclosed.

The present invention also provides a method for controlling unwanted or harmful insect pests comprising applying an effective amount of the composition disclosed herein to a plant, a locus thereof, propagation material thereof, or an area infested with the unwanted insects so as to thereby control the unwanted insects. Of particular note is the selective control of plant-sap-sucking Hemipteran and Homopteran insects including aphids, whiteflies and planthoppers. Areas infested with the unwanted insects may clearly include structures.

The present invention also provides a method for improving the speed at which control of unwanted or harmful insect pests is achieved comprising applying an effective amount of the composition disclosed herein to a plant, a locus thereof, propagation material thereof, or an area infested with the unwanted insects so as to thereby control the unwanted insects wherein the improved speed is reflected in the percentage mortality of insect pests or efficacy measured a single day after application. Of particular note is the faster selective control of plant-sap-sucking Hemipteran and Homopteran insects including aphids, whiteflies and planthoppers.

The present invention also provides a method for controlling plant disease caused by unwanted or harmful insect comprising applying an effective amount of the composition disclosed herein to a plant, a locus thereof, propagation material thereof, or an area infested with the unwanted insect so as to thereby control the plant disease caused by unwanted insect.

The pymetrozine compatibilizing agent (PCA) of the invention is sometimes usefully referred to as a formulation aid due to the improved pymetrozine formulations made possible by the inclusion of the pymetrozine compatibilizing agent (PCA). No inference should be drawn from referring to one pymetrozine compatibilizing agent as a “surfactant” and another (or even the same), as a “formulation aid” as, to a not insignificant extent, the terms may overlap within the bounds of this invention.

The present invention also provides a method for controlling unwanted insects comprising,
(1) obtaining a suspension comprising,
   a. pymetrozine,
   b. a PCA acting as a formulation aid agent,
   c. stearic acid and
   d. water,
(2) contacting a plant, a locus thereof, propagation material thereof, or an area infested with the unwanted insects with an effective amount of the suspension,
   so as to thereby control the unwanted insects.

Advantageously the control is selective control of unwanted insect pests while leaving useful invertebrates unharmed.

### BRIEF DESCRIPTION OF THE FIGURES

FIG. 1 shows results of Comparative Efficacy Example by Number of Aphids

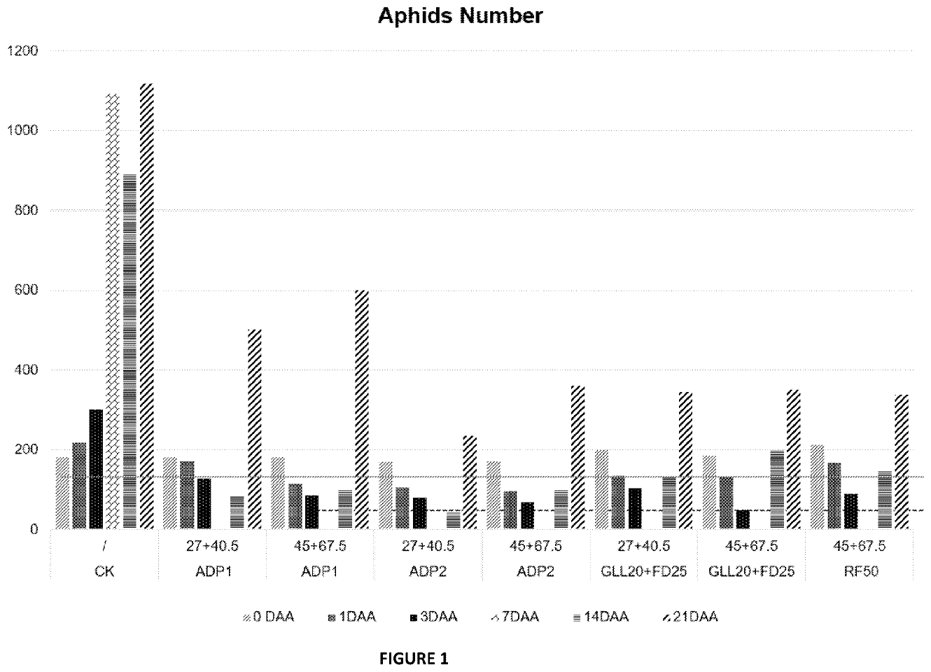

FIG. 2 shows results of Comparative Efficacy Example by Percentage Efficacy

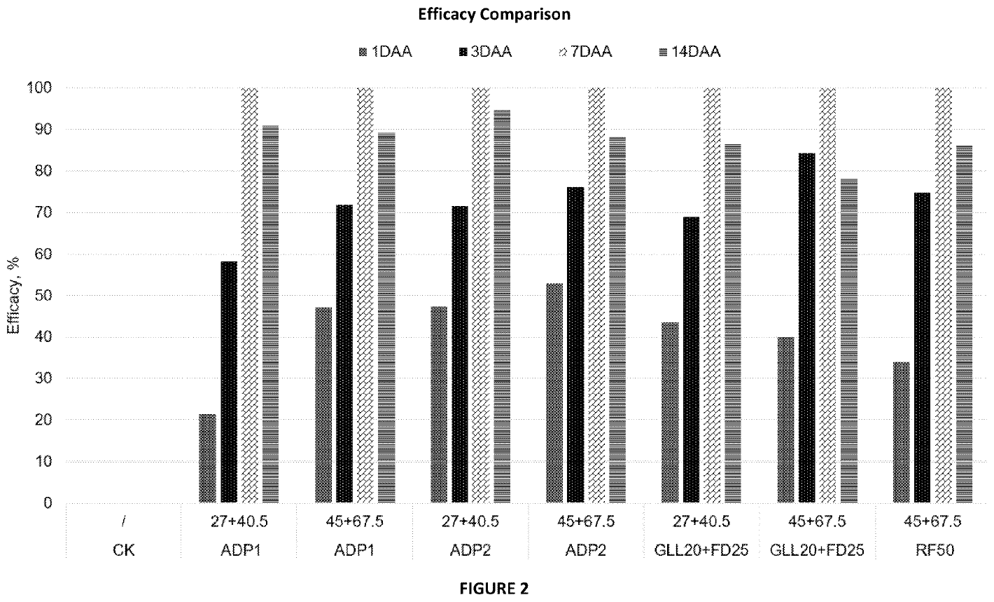

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

As used herein, the term “adjuvant” is defined as any substance that is not an active ingredient, but which enhances or is intended to enhance the effectiveness of the active ingredient, for example pesticide, with which it is used Adjuvants may include, but are not limited to, spreading agents, penetrants, compatibility agents, and drift retardants.

As used herein, the term “tank mix” means at least two of the components (such as composition and additional agrochemical, adjuvant) mixed in a tank.

As used herein, the term “plant” includes reference to the whole plant, plant organ (e.g., leaves, stems, twigs, roots, trunks, limbs, shoots, fruits etc.), or plant cells.

As used herein, the term “plant” includes reference to agricultural crops including field crops (soybean, maize, wheat, rice, etc.), vegetable crops (potatoes, cabbages, etc.) and perennial crops including fruits (peach, etc.).

As used herein, the term “propagation material” is to be understood to denote all the generative parts of the plant such as seeds and spores, vegetative structures such as bulbs, corms, tubers, rhizomes, roots stems, basal shoots, stolons and buds.

As used herein, the term “locus” includes not only areas where pests including weeds, insects, fungus, etc. may already exist, but also areas where a pest has yet to emerge, and also to areas under cultivation.

As used herein, the term “ha” refers to hectare.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”.

For the purposes of the following detailed description, it is to be understood that the invention may assume various alternative variations and step sequences, except where expressly specified to the contrary. Moreover, other than in any completed examples, or where otherwise indicated, all numbers expressing, for example, quantities of materials/ingredients used in the specification are to be understood as being modified in all instances by the term “about”.

The term “about” as used herein specifically includes ±10% from the indicated values in the range except where expressly specified to the contrary or the context clearly demands otherwise. In addition, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention using accepted rounding methods. For example, “10-50%” includes 9.5%, 10%, 10.1%, 10.2%, etc. up to 50.4%.

Formulating aqueous (water-based), compositions comprising pymetrozine especially at concentrations above 20% is challenging due to water absorption by the pymetrozine which leads to high viscosity and creamy form of the composition.

It was found that formulating pymetrozine in the presence of a pymetrozine compatibilizing agent which acts as a flowability aid agent such as phosphoric acid dialkyl ester improves the physical properties of water suspensions comprising pymetrozine during preparation and/or storage.

It was also found that fatty acids exemplified by stearic acid and derivatives thereof further stabilized water diluted suspensions comprising particulate pymetrozine. This advantage may be seen as additional to the improvements in compounding and formulation attributable to the inclusion of pymetrozine compatibilizing agents (PCA) as disclosed throughout.

### Composition

The present invention provides water-based (aqueous) compositions of (1) an amount of pymetrozine and (2) an amount of at least one pymetrozine compatibilizing agent which are typically surfactant and/or flowability aid agents selected from phosphoric acid alkyl esters, phosphonic sulfuric acid alky ester, sulphonic acid, phosphoric acid di-alkyl esters, phosphate ester surfactant, phosphonic sulfuric acid alky esters, sulphonic acid, sulfonate surfactant, and combinations thereof ester etc., as detailed above and combinations thereof and (3) water.

In noted embodiments the inventive water-based (aqueous) compositions of pymetrozine are characterized by improved flowability evidenced by improved and/or stable viscosity characteristics, as compared with equivalent compositions that do not contain the pymetrozine compatibilizing agent.

In particularly noted embodiments the photostability of the pymetrozine contained in the inventive water-based (aqueous) compositions of pymetrozine is improved evidenced by a lengthened photodegradation half-life. This improved photostability may, in noted embodiments of the invention, be particularly pronounced in those composition embodiments comprising photo-stabilizing additives together with the pymetrozine compatibilizing agent. inventors expect that the photostability of the pymetrozine contained in the inventive water-based (aqueous) compositions of pymetrozine combined with pymetrozine compatibilizing agent, may be particularly improved with additives chosen from, light stabilizers, UV absorbers, radical scavengers, antioxidants, sequestrants, pigments, etc., which are compatible with pymetrozine.

In noted embodiments the inventive water-based (aqueous) compositions of pymetrozine are characterized by improved flowability evidenced by improved and/or stable viscosity characteristics, as compared with equivalent compositions that do not contain the pymetrozine compatibilizing agent.

In some embodiments, the present invention provides a composition of (1) an amount of pymetrozine,(2) an amount of a pymetrozine compatibilizing agent which is a phosphoric acid di-alkyl ester and (3) water.

In some embodiments, the composition is a suspension concentrate composition comprising (1) pymetrozine, (2) phosphoric acid di-alkyl ester as a pymetrozine compatibilizing agent and (3) water.

In some embodiments, the present invention provides a composition of (1) an amount of pymetrozine,(2) an amount of a pymetrozine compatibilizing agent (PCA), (3) water and (4) a vinylpyrrolidone polymer or homopolymer dispersant.

In some embodiments, the pymetrozine in the composition is its hydrated form (Hydrate).

In some embodiments, the pymetrozine in the composition is in its anhydrous form (Anhydrate).

In some embodiments, the pymetrozine in the composition is included in its anhydrous form and the rate at which it is converted to its other solid, polymorphic or amorphous forms and notably solvates, particularly, its hydrate form is notably reduced. This can be labelled solid form conversion stability, although simply as a convenience.

In some embodiments, the pymetrozine in the composition is included in its hydrate form and the form of the pymetrozine remains stable to conversion over a period of storage.

In some embodiments, the pymetrozine in the composition is included in its anhydrous form (Anhydrate) and the rate at which it is converted to its hydrate form is notably reduced.

In some embodiments, the inventive water-based pymetrozine composition comprises additional pesticide besides pymetrozine (for example, as ready mix)

In some embodiments, the composition is mixed with the additional pesticide as tank mix.

In some embodiments, the pesticide is insecticide.

In some embodiments, the insecticide is flonicamid, pyridaben, Imicyafos, Thiacloprid, Ethiprole, Ethion, Thiamethoxam, imidacloprid, fenoxycarb, mobucin, nitenpyram, abamectin, buprofezin, pyriproxyfen, etofenprox, acetamiprid or any other insecticide of the same classes. Importantly inventors have specifically envisioned their inventive water-based pymetrozine compositions as being useful vehicles for improving compositions comprising pymetrozine and additional pesticides, particularly insecticides, that have been shown to be beneficially combined with pymetrozine. In this respect the scope of the composition invention is not limited by the identity of any additional biologically useful ingredient, being established as a useful co-pesticide, other than if the additional pesticide negates the advantages realized by the inclusion of the additional insecticide.

In some embodiment, the concentration of the pymetrozine in the composition is above 10% by weight based on the total weight of the composition.

In some embodiments, the weight ratio between the pymetrozine and water in the suspension concentrate is between 1:6 to 1:0.7. In some exemplified embodiments the weight ratio between the pymetrozine and water in the suspension concentrate is 0.63±10% (0.57-0.69).

In some embodiments, the concentration of the pymetrozine in the improved composition is above 20% weight by weight based on the total weight of the composition.

In some embodiments, the concentration of the pymetrozine in the composition is in excess of 27% weight by weight based on the total weight of the composition.

In some embodiments, the concentration of the pymetrozine in the improved composition is 44%±10% by weight based on the total weight of the composition.

In some embodiments, the concentration of the pymetrozine in the improved composition is as much as 55%±10% by weight based on the total weight of the composition.

In some embodiments, the water content in the aqueous pymetrozine particulate suspension compositions of the invention in any of the above embodiments, is less than 75% by weight based on the total weight of the composition.

In some embodiments, the water content in the composition is less than or equal to 70% w/w by weight based on the total weight of the composition.

In some embodiments, the water content is the composition is less than or equal to 50% w/w by weight based on the total weight of the composition.

In several exemplified embodiments the water content is 42%±10% by weight based on the total weight of the composition.

In some embodiments, the weight ratio between the pymetrozine compatibilizing agent which may have any one or more of surfactant, flowability, stability, and/or crystallization inhibitor characteristics and the pymetrozine is from 1:5±10% to 1:40±10% (about 1:5 to about 1:40). In some embodiments, the weight ratio between the PCA exemplified by phosphoric acid di alkyl ester and pymetrozine is from 1:8±10% to 1:25±10% (about 1:8% to about 1:25).

The pymetrozine compatibilizing agent is selected from one or more of, monoalkyl phosphate; dialkyl phosphate; a dialkyl ester of sulfonated succinic acid or salt thereof and any and all combinations thereof.

In some embodiments, the weight ratio between the phosphoric acid di-alkyl ester, as a PCA, and pymetrozine in the composition is from 1:13±10% to 1:22±10%. In some embodiments, the weight ratio between the phosphoric acid di alkyl ester and pymetrozine is from 1:15±10% to 1:22±10%.

In some embodiments, the concentration of phosphoric acid di alkyl ester (PCA), is at least 0.5%, preferably at least 1% by weight based on the total weight of the composition (w/w).

In some embodiments, the concentration of phosphoric acid di alkyl ester is from about 1% to 5%±10% (about 5%), by weight based on the total weight of the composition.

In some embodiments, the composition comprises at least one surfactant or more particularly, when the pymetrozine compatibilizing agent itself has surfactant properties, an additional at least one surfactant is intended.

In some embodiments, the (additional), surfactant included in the pymetrozine solid particulate aqueous suspension, may be but, is certainly not limited to anionic, nonionic and or amphoteric surfactant and can be mixtures of two or more thereof.

The pymetrozine compatibilizing agent (PCA), of the invention can itself commonly be a surfactant as alluded to above and both surfactant type pymetrozine compatibilizing agents and the additional surfactants, in noted cases can function as dispersant, wetting agent and combinations thereof.

In some embodiments, the (additional) surfactant/dispersant/wetting agent is selected from the group of, condensate of alkyl naphthalene sulfonate formaldehyde, alkyl phenol sulfonate condensate, silicone surfactant, sodium salt, ethoxylated fatty alcohol, hydrophobically modified polyacrylate, lignosulfonates, AMPS-Acrylate copolymers and block copolymers are of particular note, polyelectrolyte block copolymer (as described in WO2017/098325), polyvinylpyrrolidone, vinylpyrrolidone (homo) polymers, vinyl pyrrolidone/vinyl acetate copolymer, polycarboxylate modified with alkyl, polycarboxylate modified with aromatic group, sulfonate group modified, sulfonate group modified, naphthalene sulphonate condensate, benzenesulfonic acid, hydroxy-, polymer with formaldehyde, phenol and urea sodium salt poly(oxy-1,2-ethanediyl), .alpha.-sulfo-omega.[tris(1-phenylethyl)phenoxy-, ammonium salt, polyacrylate comb copolymer, polycarboxylate, PO/EO Block Copolymer (EO/PO/EO), fatty alcohol polyglycol ether, alcohols, ethoxylated, sulfated, ammonium salts, sodium ethoxylated alkyl sulfate, alkoxylated poly-aryl phenol phosphate salt, poly(ethylene glycol-co-propylene glycol) phosphoric acid ester sodium salt, fatty alcohol polyoxyethylene polyoxypropylene ether phosphate salt, acrylate block copolymer and any combination thereof.

In some embodiments, the polyelectrolyte is an AMPS-Acrylate copolymer and particularly noted is a block copolymer useful as a pymetrozine compatibilizing agent exemplified by that copolymer provided as a 30% by weight aqueous solution of a block polymer comprising 77% of sodium 2-acryloylamino-2-methylpropane-1-sulfonate (AMPS) monomers and 23% of ethyl acrylate (EA) monomers.

In some embodiments, the polyelectrolyte block copolymer is a block polymer that comprises 77% of sodium 2-acryloylamino-2-methylpropane-1-sulfonate (AMPS) monomers and 23% of the ethyl acrylate (EA) monomers.

In some embodiments, the polyvinylpyrrolidone K30 is PVP K30.

In some embodiments, the polyvinylpyrrolidone K17 is PVP K17.

Interestingly, polyvinylpyrrolidones, and several other useful additives in the inventive compositions are those generally known in the field of art to prevent and/or inhibit interconversion and/or recrystallization of solid compounds referred to as “crystal poisoner”.

It has now been established by inventors that compounding flowable aqueous pymetrozine formulations having reasonably low viscosities, using pymetrozine anhydrate as an ingredient can be made even more difficult due at least in part to the conversion of the pymetrozine to its hydrate form in contact with water.

Thus, inventors expect that the choice of this type of “Crystal Poisoner” or crystallization inhibitor additive in the aqueous pymetrozine suspensions made possible by the invention, are even further advantaged.

Interestingly, the types of compounds exemplified by polyvinylpyrrolidones, vinylpyrrolidone homopolymer, have been associated with protecting some compounds which are sensitive to degradation in acidic environments, see PCT/US01/11514, and thus inventors expect that similar compounds may further contribute to the chemical stability of the pymetrozine which is reportedly stable at particular ranges of pH. The pymetrozine combinations and compositions of this invention are surprisingly chemically stable and no appreciable degradation of pymetrozine was found in any exemplified inventive composition even though typically the inventive combinations and compositions are formulated with a pH of approximately 4 or below. In some, if not all of the exemplified, embodiments the stable compositions are around pH=3.5 or thereabout.

Clearly, being able to maintain pymetrozine stability over a wide range of acidity/alkalinity (measured as pH in aqueous systems), is an additional advantage of this type of composition additive, although inventors stress that this does not indicate a specifically vital choice or a preference for this specific additive type, although it may be a further consideration when one of the other ingredients (e.g., an additional insecticide) of a desired composition requires a pH environment which is normally deleterious for pymetrozine stability. All the combinations and compositions exemplified as being prepared according to this invention were (perhaps coincidentally), at or below pH=4 and yet all were found to be stable when stored at accelerated storage conditions, showing no evidence of pymetrozine degradation. In itself this is a surprisingly good characteristic of the inventive compositions.

It should be clear that additives that can maintain the chemical stability of the pymetrozine, are clearly useful additives where other formulation considerations allow.

In some embodiments, the copolymers based on vinylpyrrolidone and vinyl acetate is LUVITEC® VA 64 (copolymer based on:1-vinyl-2-pyrrolidone, vinyl acetate).

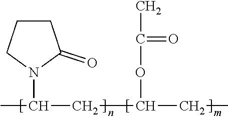 [SMILES: CCC(CC(C)N1CCCC1=O)OC(C)=O]

In some embodiments, the polycarboxylate with C₈, sulfonate group, modified is Agrilan® 700 (hydrophobically modified polyacrylate copolymer, poly(acrylic acid) backbone with PEG side chains).

In some embodiments, the polycarboxylate with benzyl sulfonate group modified is Agrilan® 789 (acrylate copolymer, hydrophobically modified copolymer).

In some embodiments, the Naphthalene sulphonate condensate is Morwet® D-425 (salt of naphthalene-sulphonic acid formaldehyde condensation product).

In some embodiments, the phenol sulfonic acid-formaldehyde condensate, sodium salt is Tamol® DN (mixture of salt of naphthalene sulphonic acid and phenol sulphonic acid condensation product).

In some embodiments, the polycarboxylate with Ph, ammonium group is SP-3275 (polycarboxylate dispersant with weak cationic properties).

In some embodiments, the Poly(oxy-1,2-ethanediyl), .alpha.-sulfo-.omega.[tris(1-phenylethyl)phenoxy-, ammonium salt is Soprophor FD (anionic tristyrylphenol ethoxylate sulfate).

In some embodiments, the Poly(oxy-1,2-ethanediyl), .alpha.-sulfo-.omega.[tris(1-phenylethyl)phenoxy-, ammonium salt is Soprophor 4D384 (anionic tristyrylphenol sulfate surfactant ammonia salt).

In some embodiments, the Poly(oxy-1,2-ethanediyl), .alpha.-sulfo-.omega.[tris(1-phenylethyl)phenoxy-, ammonium salt is YUS-FS7PG (sulphate anionic surfactant).

In some embodiments, the alkoxylated poly aryl phenol phosphate salt is Soprophor SC (alkoxylate poly aryl phenol phosphate derivatives).In some embodiments, the alkoxylated poly aryl phenol phosphate salt is Soprophor FL (CAS 99734-09-5).

In some embodiments, the Poly(ethylene glycol-co-propylene glycol) phosphoric acid ester sodium salt is Dispersogen® 4133.

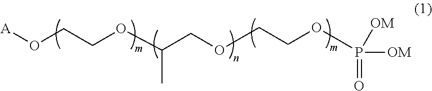

a 20% strength solution of a sodium salt of a polyalkylene glycol block copolymer of formula (I), containing phosphorus groups, with m=66, n=38 and M=sodium In some embodiments, fatty alcohol polyoxyethylene polyoxypropylene ether phosphate salt is Agrilan 1015 (alkoxylated phosphate ester).

In some embodiments, the Polyacrylate comb copolymer is Atlox® 4913 and/or Agrilan® 755 and/or Tersperse® 2500 (acrylic graft copolymer in water/propylene glycol). In some embodiments, acrylate block copolymer is Dispersogen PL 30 [Non-ionic graft copolymer CAS No. 1315321-46-0] and/or Dispersogen PL 26. In some embodiments, the Polycarboxylate is DURAMAX D-205 and/or Duramax® D-305. In some embodiments, the PO/EO Block Copolymer (EO/PO/EO) is Pluronic® PE 10500. In some embodiments, the fatty alcohol polyglycol ether is Iso-tridecyl alcohol polyglycol ether with 8 EO. In some embodiments, Iso-tridecyl alcohol polyglycol ether with 8 EO is Genapol X080. In some embodiments, the fatty alcohol polyglycol ether is C12-13, branched and linear, ethoxylated In some embodiments, the C12-13, branched and linear, ethoxylated is SAFOL 23 E7. In some embodiments, the Alcohols, ethoxylated, sulfated, ammonium salts is CEREWIN SV 2437A. In some embodiments, the sodium ethoxylated alkyl sulfate is CEREWIN SK S37.

In some embodiments, the amount of the (additional), surfactant is between 1-10%±10% w/w by weight based on the total weight of the composition.

In some embodiments, the composition further comprises an agriculturally acceptable so-called, inert additive or excipients.

In some embodiments, the agriculturally acceptable (so-called), inert additive may include but are not limited to light stabilizers, UV absorbers, radical scavengers and antioxidants, adhesives, neutralizers, thickeners, binders, sequestrants, biocides, preservatives, and anti-freeze, drift retardants, pigments, safeners. Some of these “inert” additives may have positive e.g., stabilizing effects, and inventors note that for example, the reported photodegradation of pymetrozine in contact with water is likely to be ameliorated at least to some degree by those “inert” additives that can shield from, or lessen the impact of exposure to sunlight etc. as long as they are compatible with pymetrozine. Similarly, those additives that are able to reduce the rate of hydrolytic and/or chemical damage or degradation of pymetrozine, will be useful. Likely examples of additives that can shield the pymetrozine from or lessen the impact of exposure to sunlight are selected from by any, some, or all of, light stabilizers, UV absorbers, radical scavengers, neutralizers, and antioxidants, although compatibility with pymetrozine is a consideration.

In some embodiments, the agriculturally acceptable inert additive is one or more of thickener, biocide (preservative) anti-foaming agent or combination thereof.

Inventors note that there are particular advantages, detailed elsewhere in this disclosure, in including compounds exemplified by stearic acid and similar excipients. Without being bound by any theory, it is possible that the additional advantages attained by addition of stearic acid etc., relates to its ability to form a hydrophobic barrier around the particles of pymetrozine and thus improve dispersibility.

### Surfactant/or Flowability Aid Agent Type of Pymetrozine Compatibilizing Agent

Surprisingly, it was found that adding surfactant/or flowability aid type of pymetrozine compatibilizing agent (PCA), selected from one or more of, mono alkyl phosphate; dialkyl phosphate; a dialkyl ester of sulfonated succinic acid or salt thereof and any and all combinations thereof, and exemplified by phosphoric acid di alkyl ester significantly improves the preparation process and the stability/flowability of aqueous based compositions comprising pymetrozine before and/or after storage. The PCA is usefully employed in its acid form.

In some embodiments, the surfactant/or flowability aid selected from one or more of, mono alkyl phosphate; dialkyl phosphate; a dialkyl ester of sulfonated succinic acid or salt thereof and any and all combinations thereof, is phosphoric acid di alkyl ester.

In some embodiments, the phosphoric acid di alkyl ester comprises 8 and 10 carbon atoms in each ester alkyl chain respectively.

In some embodiments, the pymetrozine compatibilizing agent surfactant selected from one or more of, mono alkyl phosphate; dialkyl phosphate; a dialkyl ester of sulfonated succinic acid or salt thereof and any and all combinations thereof is preferably phosphoric acid n-octyl, n-decyl ester.

In some embodiments, the pymetrozine compatibilizing agent (PCA), surfactant selected from one or more of, mono alkyl phosphate; dialkyl phosphate; a dialkyl ester of sulfonated succinic acid or salt thereof and any and all combinations thereof is the commercial product Crodafos® 810A, C₈, C₁₀ acid phosphate CAS No 68186-45-8, phosphoric acid, decyl octyl ester.

In some embodiments, the structure of the PCA, is a surfactant, which is selected from one or more of, mono alkyl phosphate; dialkyl phosphate; a dialkyl ester of sulfonated succinic acid or salt thereof and any and all combinations thereof is preferably represented by the following structure
(RO)ₙP(O)(OH)ₘ and salts thereof,
wherein, m+n=3, n=1 or 2, and
wherein when the ester is di ester R comprises R¹ and R² and wherein R¹ and R² can be the same or different.

In some embodiments, R (including each of R¹ and R²) is a saturated or unsaturated optionally branched alkyl, carbon chain.

In some embodiments, the alkyl R is linear.

In some embodiments, the alkyl R is a fatty chain.

In some embodiments, R¹ is C₈ alkyl.

In some embodiments, R² is C₁₀ alkyl.

In some embodiments, the alkyl is branched and/or straight-chain saturated and/or unsaturated aliphatic carbon chain having the specified number of carbon atoms. Thus, Cn as in “Cn alkyl” includes n carbons in a linear or branched arrangement.

In some embodiments, the PCA surfactant selected from one or more of, monoalkyl phosphate; dialkyl phosphate; a dialkyl ester of sulfonated succinic acid or salt thereof and any and all combinations thereof is phosphoric acid n-octyl, n-decyl ester.

In some embodiments, the PCA surfactant selected from one or more of, mono alkyl phosphate; dialkyl phosphate; a dialkyl ester of sulfonated succinic acid or salt thereof and any and all combinations thereof is iso-tridecyl phosphonate.

In some embodiments, the pymetrozine compatibilizing agent (PCA), is a surfactant selected from one or more of, mono alkyl phosphate; dialkyl phosphate; a dialkyl ester of sulfonated succinic acid or salt thereof and any and all combinations thereof is di iso-octyl phosphate.

In some embodiments, the PCA surfactant selected from one or more of, mono alkyl phosphate; dialkyl phosphate; a dialkyl ester of sulfonated succinic acid or salt thereof and any and all combinations thereof is dodecyl phosphate.

In some embodiments, the PCA surfactant selected from one or more of, mono alkyl phosphate; dialkyl phosphate; a dialkyl ester of sulfonated succinic acid or salt thereof and any and all combinations thereof is dioctyl sodium sulfosuccinate (acidified).

In some embodiments, the alkyl group comprises at least 6 carbon atoms

In some embodiments, the alkyl group comprises 18 carbon atoms

### Use And Method

The present invention also provides the use of at least one PCA (often a surfactant/flowability aid agent), selected from one or more of, mono alkyl phosphate; dialkyl phosphate; a dialkyl ester of sulfonated succinic acid or salt thereof and any and all combinations thereof for preparing an aqueous based composition comprising pymetrozine notably, in suspended particulate form.

The present invention also provides the use of at least one PCA surfactant selected from one or more of, mono alkyl phosphate; dialkyl phosphate; a dialkyl ester of sulfonated succinic acid or salt thereof and any and all combinations thereof for increasing the flowability of an aqueous based composition that comprises pymetrozine, notably, in suspended particulate form.

In some typical embodiments, the flowability of the suspension concentrate composition and the viscosity of the composition are usefully measured before dilution. In one example, flowability can be indicated initially, by tilting a container containing the composition. Clearly those suspension concentrate compositions that cannot be easily poured have flowability issues. The pymetrozine aqueous compositions provided by this invention are surprisingly flowable, even at high concentrations of pymetrozine.

In some notable embodiments, the viscosity of the pymetrozine suspension concentrate of the composition is reduced by at least 20% as compared to an equivalent suspension concentrate that do not include the PCA flowability aid agent.

The present invention provides the use of pymetrozine compatibilizing agents (PCA) which function as flowability aid agent for preparing a suspension concentrate composition comprising, pymetrozine and water.

The present invention also relates to use of phosphoric acid alkyl ester for maintaining the flowability of an aqueous suspensions comprising pymetrozine after storage.

In some embodiments, the composition is stable. In some embodiments, the aqueous pymetrozine suspension composition is physically stable. In some embodiments, the composition is stable after storage, including storage for the durations described below at temperatures described below.

In some embodiments, the pymetrozine composition is physically stable after it is stored for a period between 2 weeks and 24 months prior to application.

In some variations of the breadth of embodiments, the pymetrozine composition is physically stable after it is stored for a period of storage selected from,
2 weeks prior to application;
1 month prior to application;
2 months prior to application;
3 months prior to application;
6 months prior to application; and
2 weeks after storage at 54° C.

In some embodiments, stable, as used herein in connection with physical stability, refers to flowability.

In some embodiments, stable, as used herein in connection with physical stability, refers to the viscosity being maintained at acceptable levels. Often the acceptable viscosity referred to is the level of viscosity that has proved advantageous during the preparation or compounding of the compositions.

In some embodiments, the aqueous pymetrozine suspension comprises additional agrochemical, often an additional insecticide or other pesticide. Clearly the additional agrochemical may be in dissolved or particulate form and may even be contemplated as an oily solution introduced into the aqueous pymetrozine suspension as droplets or other biphasic system without departing from the invention.

### Additional Agrochemical

With reference to the inventive aqueous pymetrozine solid particulate composition, the term additional agrochemical, refers to any or all of fungicide, herbicide, insecticide, nematicide, biocide, and the like.

In some embodiments, the additional agrochemical is flonicamid, pyridaben, Imicyafos, Thiacloprid, Ethiprole, Ethion, Thiamethoxam, imidacloprid, fenoxycarb, mobucin, nitenpyram, abamectin, buprofezin, pyriproxyfen, etofenprox or acetamiprid, of note are the combinations of flonicamid and the inventive pymetrozine compositions herein disclosed. To the extent that the added agrochemical can be combined without losing the advantages attained by this invention.

When the additional agrochemical is flonicamid, the ratio between Pymetrozine and flonicamid is typically from about 1:2 to about 6:1, and preferably from about 2:1 to about 3:2. As with all values the term “about” refers to ±10% range around that figure, unless the context or surrounding text dictates otherwise.

In tests comparing dilutions of the inventive aqueous pymetrozine solid particulate composition that also includes flonicamid, with a mixture of two separate commercial concentrated compositions comprising pymetrozine and flonicamid combined in an aqueous dilution, it was found that the inventive aqueous pymetrozine solid particulate composition that also includes flonicamid had comparable efficacy. However, surprisingly the inventive compositions displayed a faster rate of efficacy such that the rate of mortality against the tested aphids a single day after application was higher when applying the diluted inventive compositions than the diluted combination of the two separate concentrates.

### Process for Preparing the Composition

The present invention also provides a process for preparing the aqueous (water-based) solid particulate suspension composition comprising (1) an amount of pymetrozine, (2) an amount of pymetrozine compatibilizing agent (PCA) surfactant selected from one or more of, mono alkyl phosphate; dialkyl phosphate; a dialkyl ester of sulfonated succinic acid or salt thereof and any and all combinations thereof and (3) water.

A typical process comprises,
(1) preparing a water solution of PCA (surfactant), selected from one or more of, mono alkyl phosphate; dialkyl phosphate; a dialkyl ester of sulfonated succinic acid or salt thereof and any and all combinations thereof as solution A,
(2) adding pymetrozine to solution A to form a suspension and
(3) milling the obtained suspension.

Commonly a typical process comprises
(1) preparing a water solution of PCA (surfactant), selected from one or more of, mono alkyl phosphate; dialkyl phosphate; a dialkyl ester of sulfonated succinic acid or salt thereof and any and all combinations thereof as solution A,
(2) adding pymetrozine to solution A to form a suspension and
(3) milling the obtained suspension, and
(4) packaging the milled suspension.

### Methods of Use

The invention also provides methods of treating a plant, or a part of a plant, against insect, comprising contacting the plant, part of the plant, locus of the pest, soil, and/or an area in which pest infestation is to be prevented with any one of the combinations and/or mixtures of compositions described herein.

In some embodiments, treating comprises protecting the plant, or a part of the plant, against the pest.

In some embodiments, treating comprises preventing, reducing and/or eliminating the presence of a pest locus of the plant, on the plant, or a part of the plant.

In some embodiments, treating comprises controlling diseases caused by insect in the plant, or a part of the plant.

In some embodiments, treating comprises improving the control of the disease caused by insect in the plant, or a part of the plant.

The invention also provides a method of increasing crop yield comprising contacting the crop plant, part of the plant, locus of the insect associated with the crop, soil, and/or an area in which insect infestation is to be prevented with any one of the combinations.

The invention also provides a method of improving plant vigour comprising contacting the plant, part of the plant, locus of the pest associated with the plant, soil, and/or an area in which pest infestation is to be prevented with any one of the combinations.

The present invention also provides a method for pest control by preventive, curative or persistence treatments of a plant disease caused by pest comprising contacting a plant, a locus thereof or propagation material thereof with an effective amount of any one of the combinations disclosed herein.

The present invention also provides use of any one of the compositions described herein for treating a plant, or a part of a plant, against a pest.

The present invention also provides use of any one of the compositions described herein for increasing crop yield.

The present invention also provides use of any one of the compositions described herein for improving plant vigor.

A compositions according to the invention is suitable for the preferably selective control of susceptible pests that are encountered in horticulture, agriculture, and forestry. The combinations are active against normally sensitive and resistant pest species and during each, all, or individual stages of development which are established as being sensitive to pymetrozine.

Preferably the control is selective control of unwanted insect pests while leaving useful invertebrates unharmed. Of particular note is the selective control of plant-sap-sucking Hemipteran and Homopteran insects including aphids, whiteflies and planthoppers.

Application to areas infested with the unwanted insects including structures are contemplated too.

In some embodiments, the composition is a concentrate which is intended or otherwise adapted, designed, packaged etc., to be diluted before application. In some embodiments, the inventive concentrate is intended or otherwise adapted, designed, packaged etc., to be diluted with water and other components such as adjuvants and/or further agriculturally useful or active compounds, in a tank mix before application.

In some embodiments, the dilution rate is low dilution rate for use in drone application sometimes referred to as LV (low volume), or ULV, such as 2% w/w or less of the present invention composition and 98% w/w of water. In some embodiments, the dilution rate is high dilution rate such as 0.5% composition, 0.25 or less of the present invention composition and water complete to 100% w/w %.

To control agricultural pests, the invention provides a use of the composition according to the invention for the protection of a plant, or a part of a plant, against a pest. In order to achieve the desired effect, said plant or plant part, or a soil, is contacted with the composition. Said composition is used, for example, to control plant-sap-sucking Hemipteran and Homopteran insects including aphids, whiteflies and planthoppers exemplified perhaps by Cotton aphids Aphis gossypii found on more than 700 plant species. Crop plants attacked by this aphid include cotton, citrus, coffee, cocoa, eggplant, cucumber, melon, pepper and many ornamental plants such as chrysanthemum and kalanchoe. Of particular note is the selective control of Hemipteran and Homopteran insects which does not adversely affect useful invertebrates. These are often a pest in greenhouses too.

For said above uses and said methods, the composition is applied by being sprayed over a plant, soil, structures in which plants are cultivated, or plant parts thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with the combination, suspension and/or mixture of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating for example, by means of wax or electrostatically, and other techniques well known in the art. In addition, combination, suspension and/or mixture may be injected into the soil.

In some embodiments, the insect is any of plant-sap-sucking Hemipteran and Homopteran insects including aphids, whiteflies and planthoppers, exemplified perhaps by Cotton aphids Aphis gossypii found on more than 700 plant species. Crop plants attacked by this aphid include cotton, citrus, coffee, cocoa, eggplant, cucumber, melon, pepper and many ornamental plants such as chrysanthemum and kalanchoe.

Of particular note is the selective control of Hemipteran and Homopteran insects which does not adversely affect useful invertebrates. These pests are often a pest in greenhouses too.

In some embodiments, the pesticide is applied at a rate effective for controlling a pest.

In some embodiments, the pesticide is applied at a rate effective for preventing infestation or infection by the pest. In some embodiments, the pesticide is applied at a rate effective for curing or removing the infestation or infection by the pest.

In some embodiments, the combination or composition comprising the combination is sprayed over a plant or a part of a plant.

In some embodiments, the combination or composition comprising the combination is sprayed in a green house.

In some embodiments, the plant part is leaf, seed or/and fruit.

In some embodiments, the composition is applied as a foliar application. In some embodiments, the composition is applied as a soil application.

In some embodiments, the composition is tank mixed with an additional agrochemical. In some embodiments, the composition is applied sequentially with the additional agrochemical.

In some embodiments, the composition is tank mixed with an additional adjuvant. In some embodiments, the composition is applied sequentially, separately, or simultaneously with additional adjuvant.

Each embodiment disclosed herein is contemplated as being applicable to each of the other disclosed embodiments. Thus, all combinations of the various elements described herein are within the scope of the invention. In addition, the elements recited in composition embodiments can be used in the concentrate, suspension, method, use, process and package embodiments described herein and vice versa.

In addition, when lists are provided in this disclosure, the list is to be considered as a disclosure of each one member of the list individually and independently of the other members of that list.

This invention will be better understood by reference to the Experimental Details which follow, but those skilled in the art will readily appreciate that the specific experiments detailed are only illustrative of exemplary parts of the scope of the invention as described more fully in the claims which follow thereafter and the experiments described are not intended to define or limit the breadth of scope of the invention.

The invention is illustrated by the disclosure and the various examples without limiting its scope thereby.

Pymetrozine is most typically formulated as an aqueous (water-based), suspension concentrate and in the experimental section below comparable compositions are prepared with and without pymetrozine compatibilizing agent (PCA) as a flowability aid agent such as phosphoric acid di alkyl ester.

To illustrate though not to limit, the scope of compositions encompassed by this this disclosure, compositions of aqueous suspensions may contain at least one pymetrozine compatibilizing agent (PCA) typically chosen from any of phosphoric acid,n-octyl,n-decyl esters, iso tridecyl phosphate, di-iso octyl phosphate, di-decyl phosphate, dioctyl sodium sulfosuccinate, and mixtures thereof. These compositions might contain additives which could be any, or a mixture of polyvinylpyrrolidone such as K30, polyvinylpyrrolidone such as K17, copolymers based on vinylpyrrolidone and vinyl acetate, polycarboxylate with C₈ sulfonate group modified, polycarboxylate with benzyl sulfonate group modified, naphthalene sulphonate condensate, benzenesulfonic acid hydroxy-, polymer with formaldehyde phenol and urea, sodium salt, AMPS-Ethyl acrylate random or block copolymer, polycarboxylate with phenoxy ammonium group, Poly(oxy-1,2-ethanediyl), .alpha.-sulfo-omega.[tris(1-phenylethyl(phenoxy-, ammonium salt, poly(oxy-1,2-ethanediyl), alpha-sulfo-.omega.[tris(1-phenylethyl(phenoxy-, ammonium salt, poly(oxy-1,2-ethanediyl), alpha.-sulfo-omega [tris(1-phenylethyl(phenoxy-, ammonium salt, alkoxylated poly aryl phenol phosphate salt Soprophor® SC, Sorprophor® FL, poly(ethylene glycol-co-propylene glycol) phosphoric acid ester sodium salt Dispersogen® 4133, fatty alcohol polyoxyethylene polyoxypropylene ether phosphate salt Agrilan® 1015, Atlox®4913, Agrilan® 755, Tersperse® 2500, Geropon® DA 1349, Dispersogen® PL 30, Dispersogen® PL 26, DURAMAX® D-205, Duramax® D-305, Pluronic® PE 10500, Genapol® X080, alcohols ethoxylated, sulfated, ammonium salts, sodium ethoxylated alkyl sulfate alcohols, C₁₂₋₁₃, branched and linear, ethoxylated.

A general method suitable for these composition forms is described here which was also the basis of the methods used in the experimental examples section of this disclosure,

### General Preparation Procedure Methods:

### Premix:

1) charge soft water into a reactor/container/vessel and start agitating (mixing).
2) add to the reactor etc.,
   i) a pymetrozine compatibilizing agent (PCA) acting as a flowability aid agent, as well as wetting agent, dispersant, antifreeze,
   ii) a first portion of defoamer,
   iii) preservative,
while mixing until the suspension is homogeneous.
(note, that for the comparative compositions below, the PCA is absent).
3) add pymetrozine tech (active ingredient compound) gradually to the reactor with stirring thus forming a suspension,
4) add the second functional technical compound (agrochemical), if required or desired, to the reactor,
5) homogenize at high sheer conditions until the suspension is homogeneous.

### Milling:

6) mill the suspension using equipment such as a bead or media mill until suspended particle size is characterized by a D₉₀≤5 μm±10% (equal or less than about 5 μm).
7) wash the reactor and the milling equipment with the water to ensure recovery of the composition and include rinse water including recovered remnants.

### Completion of Formulation:

8) add to the suspension the rest of the defoamer,
9) homogenize at high sheer conditions until the suspension is homogeneous.
10) add to the suspension a thickener, commonly xanthan gum exemplified by AG RH 23 2% gel.
11)homogenize at high sheer conditions until the suspension is homogeneous.

Commonly the preparation procedure methods are completed by a packaging step:
12) Package the suspension in suitable container.

In many typical embodiments of the method/process of preparation, the process for preparing the composition is completed by packaging the obtained homogeneous suspension in suitable containers. Suitable containers are those that maintain the surprising advantages of the inventive compositions as well as the stability of the contents over a period of storage such as the intended shelf life, including physical stability, chemical stability and photostability.

### Example A Composition of Table 1

### Method of Preparation

Wetting agents Sodium Dioctyl Sulphosuccinate, Geropon® CYA/75P, floawbility aid agent—Phosphoric acid, decyl octyl ester, Crodafos 810A, PVP, Sokalan® K30 P, Polycarboxylate with Benzyl sulfonate group modified, Agrilan® 789, Atlox® 4913, antifreeze, Propylene Glycol and half of the defoamer SAG 1572 were added to 80% of the water and agitated with an overhead stirrer, followed by addition of Flonicamid (additional pesticide AI Tech) to obtain a slurry. Agitation continued until the slurry was smooth. Pymetrozine was added slowly to the slurry while applying high shear mixing. The mixture obtained, was milled using a bead mill agitator until the PSD was characterized by a D₉₀ of the particles reduced to less than 5 μm. The remaining water, defoamer SAG 1572 and rheology modifier AG RH 23, 2% gel were then added while stirring with overhead stirrer. Density=1.164 g/cm³.

TABLE 1

| Raw Material | Detail | Note | % w/w | kg/1000 L |
|---|---|---|---|---|
| Pymetrozine | Pymetrozine | A.I. | 27 (26.24) | 310 (303) |
| (98%) | | | | |
| Flonicamid tech | Additional AI Tech | A.I. | 18 (17.5) | 209 (203) |
| (97.3%) | | | | |
| Geropon ® CYA/75P | Docusate sodium | Wetting | 0.3 | 4 (3.5) |
| | | Agent | | |
| Crodafos 810A | Phosphoric acid, | PCA | 1.5 | 18 (17.5) |
| | decyl octyl ester | | | |
| Sokalan ® K30 P | Vinylpyrrolidone | | 1 | 12 (11.6) |
| | homopolymer | | | |
| Agrilan 789 (liq) | Acrylic Copolymer/ | | 1.5 | 18 (17.5) |
| | sulfonate group | | | |
| Atlox 4913 | Polyacrylate comb | | 2.5 | 29 (29.1) |
| | copolymer | | | |
| Propylene Glycol | antifreeze | Antifreeze | 5 | 58 (58.2) |
| SAG 1572 | Defoamer | Antifoam | 0.4 | 5 (4.6) |
| AG RH 23 | Xanthan gum | Thickener | 0.1 (0.08) | 1 (0.9) |
| Wancide 520XL | BIT | Perseverative | 0.1 | 1 (1.2) |
| Water | | Carrier | Up to | Up to |
| | | | 100% | 1000 L |

### Findings for Example A—Improvement in Processing and Compounding Parameters

All formulation parameters were good. The viscosity of the formulation was low and easy to process and tilting the container, showed good flowability and the composition remained stable after storage.

Thus, it can be seen that the inventive pymetrozine compatibilizing agent (PCA) has improved and simplified the preparation of a flowable non-viscous pymetrozine suspension composition.

A further test was conducted to assess the quality of the products obtained after the inventive compositions were diluted, to assess if there was room for any further optimization.

### Dilution Test:

A sample of the suspension concentrate obtained in Example A was diluted with water at different concentrations in order to mimic the various dilutions encountered in normal use.
Test: 1 g of composition example A was mixed with 99 g of water and stirred until homogenous and the diluted sample was allowed to sit for 4 hours, aggregation and sedimentation was recorded and a wet sieve #200 mesh was blocked, diluted sample could not pass.

### Observation:

While highly diluted samples of the concentrate were “good” meaning acceptable, the samples of concentrate which were diluted to a low total volume, e.g., useful in drone application, it was observed to display a degree of aggregation and sedimentation. Thus, although the inventive pymetrozine compatibilizing agent (PCA) had proven their function as formulation aids making the preparation of the concentrates, practical, further optimization of the product through the addition of excipients was conducted.

In the next example it can be seen that the addition of stearic acid in addition to the pymetrozine compatibilizing agent (PCA), can improve the quality of the so-called “Low Dilutions” of the inventive composition exemplified by the concentrate formed in Example A.

### Example B Composition of Table 2

Optimization by Addition of Stearic Acid, Improvements in products formed from dilution of aqueous (water-based), pymetrozine suspension concentrate formulations.

TABLE 2

| | | | | Mass/ |
|---|---|---|---|---|
| | | | Content | Volume |
| Raw Material | Name | Note | % w/w | kg/1000 L |
| Pymetrozine | Pymetrozine | A.I. | 27 (26.24) | 310 (305) |
| (98%) | | | | |
| Flonicamid | Flonicamid | A.I. | 18 (17.5) | 209 (203) |
| (97.3%) | | | | |
| Genapol ® X 080 | Ethoxylated C13 | Wetting Agent | 0.5 | 6 (5.8) |
| | Oxo Alcohol | | | |
| Crodafos ® | C₈-C₁₀ acid phosphate | PCA | 1.5 | 18 (17.5) |
| 810A | CAS 68186-45-8 | | | |
| Stearic acid | | | 0.3 | 4 (3.5) |
| Sokalan ® K17 P | Vinylpyrrolidone polymer | | 1.5 | 18 (17.5) |
| | 9,000 MW | | | |
| Agrilan ® 700 | Polyacrylate copolymer | | 1 (0.8) | 9 (9.3) |
| | with sulfonate group | | | |
| Tersperse ® | Polyethylene glycol mono | | 1 | 12 (11.6) |
| 2218 | (tri styryl phenyl) ether | | | |
| | sulfate ammonium salt | | | |
| Propylene | Anti-Freeze | Antifreeze | 5 | 58 (58.2) |
| Glycol | | | | |
| SAG ® 1572 | Anti-Foam | Antifoam | 0.4 | 5 (4.6) |
| AG RH 23 | Xanthan gum | Thickener | 0.1 (0.08) | 0.9 |
| Wancide ® | BIT | Preservative | 0.1 | 1 (1.2) |
| 520XL | | | | |
| Water | | Carrier | Up to | Up to |
| | | | 100 | 1000 L |

Density = 1.164/cm3

### Findings for Example B

All formulation parameters were good. The viscosity of the formulation was low and easy to process and tilting the container, showed good flowability and remained stable after storage at 54° C.

Thus, it can be seen that the inventive pymetrozine compatibilizing agent (PCA) has improved and simplified the preparation of a flowable non-viscous pymetrozine suspension composition. In addition, to assess the quality of the products obtained after the inventive compositions were diluted a test of the quality of the diluted concentrate was conducted.

### Dilution Test:

A sample of the suspension concentrate obtained in Example B was diluted with water at different concentrations in order to mimic the various dilutions encountered in normal use.

### Observation:

Both the highly diluted samples and samples diluted to a low total volume, e.g., dilutions useful in drone application of the concentrate, were “good” displaying no appreciable aggregation or sedimentation. Thus, incorporation of Stearic acid and similar compounds in the inventive particulate pymetrozine aqueous suspension concentrates (SC) formulations are found useful in the further optimization of the diluted compositions obtainable by dilution of the SC formulations.

### Various Comparative Tests

As discussed previously, while the pymetrozine compatibilizing agents (PCA) of the invention are proven to improve the ease of preparation and quality of particulate pymetrozine aqueous suspension concentrates (SC), various options as regards the choice of ingredients of the SC can influence the quality etc., of the products produced.

### Experiments:

### Influence on the Choice Between Hydrate and Anhydrous Pymetrozine.

In order to emphasize or accentuate the comparison between the choice of pymetrozine raw material used, the following experiment was conducted without the use of the PCA flowability aid agent of the present invention. Clearly incorporation of a PCA will be beneficial to both examples, although it is expected that a difference in the level of possible improvement may be influenced by this choice between hydrate and anhydrous pymetrozine forms.

A similar observation may also be related to the choice of an ingredient that may delay, prevent, or avoid any effect attributable to interconversion between the solid (crystalline) forms of pymetrozine.

Based on the general preparative methods above, two of the following concentrates (neither containing the inventive PCA), were prepared where the difference between them is the solid form of the pymetrozine chosen.

Ingredients, and preparation were as follows:

Wetting agent, Geropon® CYA/75P, Sokalan® K30 P, Agrilan® 789, Atlox® 4913, antifreeze Propylene Glycol and half of the defoamer SAG 1572 were added to 80% of the water, agitated (overhead stirrer), followed by addition of Flonicamid, agitation continued until the slurry was smooth. Pymetrozine was added slowly to the slurry while applying high shear mixing.

The mixture was milled (bead mill agitator) until D₉₀ of the particles was reduced to less than 5 μm. Remaining amount of water, defoamer, SAG 1572 and rheology modifier, AG RH 23 2% gel were then added while stirring (overhead stirrer).

### Results:

The composition comprising anhydrous Pymetrozine tech as starting material without formulation aid agent, was difficult to process and a non-flowable paste causing blockages in a “cream” consistency. A suspension concentrate (SC) was only obtained after storage at stability testing conditions.

The composition comprising Hydrated Pymetrozine as starting material without PCA flowability aid agent, had the following appearance after stability—unacceptably high viscosity after storage at stability testing conditions.

Viscosity testing, of several samples using rheometer was conducted. The test was a shear ramp test. Viscosity being reported at certain shear rate and temperature. 0.s s⁻¹-10 s⁻¹ were chosen because this range of shear rate were found to be related to pouring ability

In general, when preparing the aqueous solid particulate SC compositions prepared with the inventive PCA formulation aid, the viscosity of the compositions was found to be about two orders of magnitude less compared to compositions prepared without the inventive PCA additive for aqueous pymetrozine suspension concentrates (SC).

For the sake of scaling comparison various non-pymetrozine compositions were tested for scale calibration, including hand cream, toothpaste, silicone oil and 2% xanthan gum.

| | | Viscosity shear | | |
|---|---|---|---|---|
| | Qualitative | rates at 25° C./cPs | | |
| Description | Appearance | 0.1 S⁻¹ | 1 S⁻¹ | 10 S⁻¹ |
| Comparative I without | cream | 1341000 | 128000 | 21000 |
| PCA formulation aid | | | | |
| INVENTIVE VI with | flowable | 27100 | 3800 | 600 |
| PCA formulation aid | suspension | | | |
| INVENTIVE X | flowable | 22000 | 3000 | 600 |
| Pymetrozine 45% | suspension | | | |
| dispersion with PCA | | | | |
| formulation aid | | | | |
| 2% xanthan gum gel | Gel (for | 215000 | 33000 | 4200 |
| | comparison) | | | |
| hand cream | cream | 78800 | 17200 | 5300 |
| silicone | cream | 13000000 | 1310000 | 126500 |

A variety of compositions were prepared to exemplify the comparison between several inventive and comparative compositions. Various exemplified inventive and comparative examples are presented summarized first in the following table, with further details to follow. The compositions exemplified include a second agrochemical as these are even harder to formulate and thus demonstrate advantages.

| | Description of | |
|---|---|---|
| Example | Relevant components | Comment |
| INVENTIVE | PYM 300/Flonicamid 200 SC | Good SC formulation, |
| I | PYM 26.2%/Flonicamid 17.5% | Passes requirement for |
| | Comprising PCA Formulation aid: | SC formulation |
| | Crodafos ® 810A | |
| INVENTIVE | PYM 300/Flonicamid 200 SC | Good SC formulation, |
| II | PYM 26.2%/Flonicamid 17.5% SC | Passes requirement for |
| | Comprising PCA Formulation aid: | SC formulation |
| | mono Iso-tridecyl phosphate | |
| INVENTIVE | PYM 300/Flonicamid 200 SC | Good SC formulation, |
| III | PYM 26.2%/Flonicamid 17.5% SC | Passes requirement for |
| | Comprising PCA Formulation aid: | SC formulation |
| | Di-iso-octyl phosphate | |
| INVENTIVE | PYM 300/Flonicamid 200 SC | Good SC formulation, |
| IV | PYM 26.2%/Flonicamid 17.5% SC | Passes requirement for |
| | Comprising PCA Formulation aid: | SC formulation |
| | Dioctyl Sodium Sulfosuccinate, | |
| | acidified | |
| INVENTIVE | PYM 300/Flonicamid 200 SC | Good SC formulation, |
| V | PYM 26.2%/Flonicamid 17.5% | Passes requirement for |
| | Comprising PCA Formulation aid: | SC formulation |
| | Crodafos ® 810A | |
| | another composition | |
| INVENTIVE | PYM 300/Flonicamid 200 SC | Good SC formulation, |
| VI | PYM 26.2%/Flonicamid 17.5% | Passes requirement for |
| | Comprising PCA Formulation aid: | SC formulation |
| | Crodafos ® 810A | Improved quality of |
| | Incorporating Stearic Acid | SC after dilution with |
| | | both high and low |
| | | dilution |
| Comparative | Comparative to INVENTIVE I, | after addition of PYM, |
| I | absent the PCA formulation aid, | the mixture became a |
| | using anhydrous PYM raw material | cream, an acceptable |
| | | SC formulation could |
| | | not be formed |
| Comparative | Comparative composition, absent | Initial SC formed, |
| II | the PCA formulation aid, | however after |
| | using hydrated PYM raw material | stability storage at |
| | | 54° C. for one day, |
| | | it became an |
| | | unacceptable cream |
| INVENTIVE | PYM 300/Flonicamid 200 SC | Good SC formulation, |
| VII | PYM 26.2%/Flonicamid 17.5% | Passes requirement for |
| | Comprising PCA Formulation aid: | SC formulation |
| | Crodafos ® 810A | |
| | Another Composition | |
| INVENTIVE | PYM 300/Flonicamid 200 SC | Good SC formulation, |
| VIII | PYM 26.2%/Flonicamid 17.5% | Passes requirement for |
| | Comprising PCA Formulation aid: | SC formulation |
| | Crodafos ® 810A | |
| | Another Composition | |
| INVENTIVE | PYM 300/Flonicamid 200 SC | Good SC formulation, |
| IX | PYM 26.2%/Flonicamid 17.5% | Passes requirement for |
| | Comprising PCA Formulation aid: | SC formulation |
| | Crodafos ® 810A | |
| | Another Composition | |
| INVENTIVE | PYM 515 SC | good SC formulation, |
| X | PYM 44% SC | can pass requirement |
| | Comprising PCA Formulation aid: | for SC formulation |
| | Crodafos ® 810A | |
| INVENTIVE | PYM 300/Flonicamid 200 SC | Good SC formulation, |
| XI | PYM 26.2%/Flonicamid 17.5% | Passes requirement for |
| | Comprising PCA Formulation aid: | SC formulation |
| | Crodafos ® 810A | |
| | Alternative Composition | |
| INVENTIVE | PYM 300/Flonicamid 200 SC | Good SC formulation, |
| XII | PYM 26.2%/Flonicamid 17.5% | Passes requirement for |
| | Comprising PCA Formulation aid: | SC formulation |
| | Crodafos ® 810A | |
| | Alternative Composition | |
| INVENTIVE | PYM 300/Flonicamid 200 SC | Good SC formulation, |
| XIII | PYM 26.2%/Flonicamid 17.5% | Passes requirement for |
| | Comprising PCA Formulation aid: | SC formulation |
| | Crodafos ® 810A | |
| | Alternative Composition | |

note,
PYM = Pymetrozine AI

INVENTIVE I

| Raw Material | Name | Note | % w/w | kg/1000 L |
|---|---|---|---|---|
| Pymetrozine | Pymetrozine | A.I. | 27 (26.24) | 310 (305) |
| (98%) | | | | |
| Flonicamid | Flonicamid | A.I. | 18 (17.5) | 209 (203) |
| (97.3%) | | | | |
| SAFOL 23E7 | Alcohols, | | 0.3 | 4 (3.5) |
| | C12-13, | | | |
| | branched and | | | |
| | linear, | | | |
| | ethoxylated | | | |
| Crodafos 810A | Phosphoric | PCA | 1 (1.2) | 14 |
| | acid, decyl | | | |
| | octyl ester | | | |
| Sokalan K30 P | Vinylpyrrolidone | | 1 (0.8) | 9 (9.3) |
| Agrilan 789 | Acrylic | | 1 (1.2) | 14 |
| (liq) | Copolymer | | | |
| | with sulfonate | | | |
| | group | | | |
| Atlox 4913 | Acrylic | | 2 | 23 (23.3) |
| | Copolymer | | | |
| Propylene | Propylene | | 5 | 58 (58.2) |
| Glycol | Glycol | | | |
| SAG 1572 | | | 0.2 | 2 (2.3) |
| AG RH 23 | Xanthan gum | | 0.1 (0.06) | 1 (0.7) |
| Wancide | BIT | | 0.1 | 1 (1.2) |
| 520XL | | | | |
| Water | | Carrier | Up to | Up to |
| | | | 100 | 1000 L |

[PCA = Phosphoric acid, decyl octyl ester] Density=1.164 g/ml

INVENTIVE II

| Raw Material | Name | Note | % w/w | kg/1000 L |
|---|---|---|---|---|
| Pymetrozine | Pymetrozine | A.I. | 27 (26.24) | 310 (305) |
| (98%) | | | | |
| Flonicamid | Flonicamid | A.I. | 18 (17.5) | 209 (203) |
| (97.3%) | | | | |
| mono iso | mono iso | PCA | 1.5 | 18 (17.5) |
| tridecyl | tridecyl | | | |
| phosphate | phosphate | | | |
| CYA/75P | Docusate | | 0.4 | 5 (4.7) |
| | sodium | | | |
| Sokalan ® K30 P | Vinylpyrrolidone | | 1 | 12 |
| Agrilan ® 789 | Acrylic | | 1.5 | 18 |
| (liq) | Copolymer with | | | |
| | sulfonate group | | | |
| Atlox 4913 | Acrylic | | 2.5 | 29 |
| | Copolymer | | | |
| Propylene Glycol | Propylene | | 5 | 58 |
| | Glycol | | | |
| SAG 1572 | | | 0.2 | 2.3 |
| AG RH 23 | Xanthan gum | | 0.1 (0.06) | 1 (0.7) |
| Wancide 520XL | BIT | | 0.1 | 1.2 |
| Water | Carrier | | Up to | Up to |
| | | | 100 | 1000 L |

[PCA = mono Iso-tridecyl phosphate] PCA formulation aid, Density = 1.164 g/ml

INVENTIVE III

| Raw Material | Name | Note | % w/w | kg/1000 L |
|---|---|---|---|---|
| Pymetrozine | Pymetrozine | A.I. | 27 (26.24) | 310 (305) |
| (98%) | | | | |
| Flonicamid | Flonicamid | A.I. | 18 (17.5) | 209 (203) |
| (97.3%) | | | | |
| Lutensol TO 8 | Iso tri decanol, | | 10 | 116 |
| | ethoxylated | | | |
| Di-iso octyl | di-iso octyl | PCA | 1.4 | 16 |
| phosphate | phosphate | | | |
| Sokalan K30 P | Vinylpyrrolidone | | 0.5 | 6 |
| Agrilan 789 (dry) | Acrylic | | 0.5 | 6 |
| | Copolymer | | | |
| | with sulfonate | | | |
| | group | | | |
| Atlox 4913 | Acrylic | | 1.5 | 18 |
| | Copolymer | | | |
| AMPS-Ethyl | Block | | 3.5 | 40 |
| Acrylate | Co-polymer | | | |
| Genapol PF 40 | Polypropylene | | 1 | 12 |
| | glycol | | | |
| Ethylene Glycol | ethylene Glycol | | 4 | 47 |
| SAG 1572 | | | 0.4 | 5 |
| AG RH 23 | Xanthan gum | | 0.1 (0.06) | 1 (0.7) |
| Wancide 520XL | BIT | | 0.1 | 1.2 |
| Water | | Carrier | Up to | Up to |
| | | | 100 | 1000 L |

[PCA = di-iso-octyl phosphate]

INVENTIVE IV

| Raw Material | Name | Note | % w/w | kg/1000 L |
|---|---|---|---|---|
| Pymetrozine | Pymetrozine | A.I. | 27 (26.24) | 310 (305) |
| (98%) | | | | |
| Flonicamid | Flonicamid | A.I. | 18 (17.5) | 209 (203) |
| (97.3%) | | | | |
| CYA/75P | Dioctyl sodium | PCA | 2.5 | 29 (29.1) |
| | sulfosuccinate | | | |
| HCI (25%) | HCl | | 1 (0.6) | 7 |
| Sokalan ® | Vinylpyrrolidone | | 1 (1.2) | 14.0 |
| K17 | | | | |
| Agrilan 789 | Acrylic | | 1 (1.1) | 13 (12.8) |
| (liq) | Copolymer | | | |
| | with sulfonate | | | |
| | group | | | |
| Emulsogen ® | butanol | | 2 | 23 (23.3) |
| 3510 | derived | | | |
| | EO/PO block | | | |
| | copolymer | | | |
| Propylene | Anti-freeze | | 5 | 58 (58.2) |
| Glycol | | | | |
| SAG 1572 | | | 0.3 | 4 (3.5) |
| AG RH 23 | Xanthan gum | | 0.1 (0.06) | 1 (0.7) |
| Wancide ® | BIT | | 0.1 | 1 (1.2) |
| 520XL | | | | |
| Water | | Carrier | Up to | Up to |
| | | | 100 | 1000 L |

[PCA = dioctyl sodium sulfosuccinate]

INVENTIVE V [PCA = Phosphoric acid, decyl octyl ester]

| Raw Material | Name | Note | % w/w | | kg / 1000 L | |
|---|---|---|---|---|---|---|
| Pymetrozine (98%) | Pymetrozine | A.I. | 27 | (26.24) | 310 | (305) |
| Flonicamid | Flonicamid | A.I. | 18 | (17.5) | 209 | (203) |
| (97.3%) | | | | | | |
| Genapol X080 | Ethoxylated C₁₃ Oxo Alcohol | | 0.5 | | 6 | |
| Crodafos 810A | Phosphoric acid, decyl octyl ester | PCA | 1.5 | | 18 | |
| Sokalan K17 P | Vinylpyrrolidone polymer | | 1.5 | | 18 | |
| Agrilan 700 | Polyacrylate copolymer with sulfonate group | | 0.8 | | 9 | |
| Tersperse 2218 | Polyethylene glycol mono(tristyrylphenyl) ether | | 1 | | 12 | |
| | sulfate ammonium salt | | | | | |
| Propylene Glycol | Anti-freeze | | 5 | | 58 | |
| SAG 1572 | | | 0.4 | | 5 | |
| AG RH 23 | Xanthan gum | | 1 | (0.08) | 1 | (0.9) |

| | | | | |
|---|---|---|---|---|
| Wancide 520XL | BIT | 0.1 | 1 | (1.2) |

| | | | |
|---|---|---|---|
| Water | Carrier | Up to 100 | Up to 1000 L |

INVENTIVE VI [PCA = Phosphoric acid, decyl octyl ester] &
Stearic Acid [INVENTIVE V + Stearic Acid]

| Raw Material | Name | Note | % w/w | | kg / 1000 L | |
|---|---|---|---|---|---|---|
| Pymetrozine(98%) | Pymetrozine | A.I. | 27 | (26.24) | 310 | (305) |
| Flonicamid | Flonicamid | A.I. | 18 | (17.5) | 209 | (203) |
| (97.3%) | | | | | | |
| Genapol X 080 | Ethoxylated C₁₃ Oxo Alcohol | | 0.5 | | 6 | |
| Crodafos 810A | Phosphoric acid, decyl octyl ester | PCA | 1.5 | | 17 | |
| Stearic acid | Stearic acid | | 0.3 | | 4 | (3.5) |
| Sokalan K17 P | Vinylpyrrolidone polymer | | 1.5 | | 18 | (17.5) |
| Agrilan 700 | Polyacrylate copolymer with sulfonate group | | 1 | (0.8) | 9 | |
| Tersperse 2218 | Polyethylene glycol mono(tristyrylphenyl) ether | | 1 | | 12 | |
| | sulfate ammonium salt | | | | | |
| Propylene Glycol | Propylene Glycol | | 5 | | 58 | |
| SAG 1572 | | | 0.4 | | 5 | |
| AG RH 23 | Xanthan gum | | 0.1 | (0.08) | 1 | (0.9) |

| | | | | |
|---|---|---|---|---|
| Wancide 520XL | BIT | 0.1 | 1 | (1.2) |

| | | | |
|---|---|---|---|
| Water | Carrier | Up to 100 | Up to 1000 L |

### Comparative I Anhydrous PYM [INVENTIVE I, Absent the PCA Formulation Aid]

| Raw Material | Name | Note | % w/w | | kg / 1000 L | |
|---|---|---|---|---|---|---|
| Pymetrozine(98%) | Pymetrozine | A.I. | 27 | (26.24) | 310 | (305) |
| Flonicamid (97.3%) | Flonicamid | A.I. | 18 | (17.5) | 209 | (203) |
| SAFOL 23E7 | Alcohols, C₁₂₋₁₃, branched/linear, ethoxylated | | 0.3 | | 4 | (3.5) |
| Sokalan ® K30 P | Vinylpyrrolidone | | 0.8 | | 9 | |
| Agrilan 78 (liq) | Acrylic Copolymer with sulfonate group | | 1 | (1.2) | 14 | |
| Atlox 4913 | Acrylic Copolymer | | 2 | | 23 | |
| Propylene Glycol | Anti-Freeze | | 5 | | 58 | |
| SAG 1572 | | | 0.2 | | 2 | (2.3) |
| AG RH 23 | Xanthan gum | | 0.1 | (0.06) | 1 | (0.7) |

| | | | | |
|---|---|---|---|---|
| Wancide 520XL | BIT | 0.1 | 1 | (1.2) |

| | | | |
|---|---|---|---|
| Water | Carrier | Up to 100 | Up to 1000 L |

After addition of Pymetrozine, the mixture became “Cream”, unable to prepare an SC formulation.

### Comparative II Hydrated PYM [Absent the PCA Formulation Aid]

| Raw Material | Name | Note | % w/w | | kg / 1000 L | |
|---|---|---|---|---|---|---|
| Pymetrozine (85%) | Hydrated Pymetrozine, 13% water | A.I. | 31 | (26.24) | 360 | (305) |
| Flonicamid (97.3%) | Flonicamid | A.I. | 18 | (17.5) | 209 | (203) |
| Morwet D-425 | Naphthalene sulphonate condensate | | 1 | (0.7) | 8 | (8.15) |
| DURAMAX D-305 | Polycarboxylate | | 4 | (3.5) | 40 | (40.7) |
| Tersperse 2612 | Polymeric surfactant | | 3 | | 35 | (34.9) |
| Atlox 4913 | Acrylic Copolymer | | 2 | (2.3) | 27 | (26.8) |

| | | | | |
|---|---|---|---|---|
| Propylene Glycol | Propylene Glycol | 5 | 58 | (58.2) |
| SAG 1572 | | 0.1 | 1 | (1.2) |
| AG RH 23 | Xanthan gum | 0.04 | 0.5 | (0.47) |
| Wancide 520XL | BIT | 0.1 | 1 | (1.16) |

| | | | |
|---|---|---|---|
| Water | Carrier | Up to 100 | Up to 1000 L |

Initial appearance seems normal/acceptable SC, however, after stability storage at 54° C. for one day, became “cream” - Unacceptable.

INVENTIVE VII [PCA = Phosphoric acid, decyl octyl ester] Alternative Formulation

| | | | | | kg / 1000 | |
|---|---|---|---|---|---|---|
| Raw Material | Name | Note | % w/w | | L | |
| Pymetrozine(98%) | Pymetrozine | A.I. | 27 | (26.24) | 310 | (305) |
| Flonicamid (97.3%) | Flonicamid | A.I. | 18 | (17.5) | 209 | (203) |

| Lutensol TO 8 | Iso-tri decanol, ethoxylated | | 1 | 12 | |
|---|---|---|---|---|---|
| Crodafos 810A | Phosphoric acid, decyl octyl ester | PCA | 1.5 | 18 | (17.5) |
| Sokalan K17 P | Vinylpyrrolidone polymer | | 1.5 | 18 | (17.5) |
| PE10500 | EO/PO polymer | | 1 | 12 | |
| Tamol DN | Sodium Phenol sulphonate condensate | | 0.5 | 6 | |
| Propylene Glycol | Propylene Glycol | | 5 | 58 | |
| SAG 1572 | | | 0.4 | 5 | |
| AG RH 23 2% gel | Xanthan gum | | 2 | 23 | |
| Wancide 520XL | BIT | | 0.1 | 1 | (1.2) |

| | | | |
|---|---|---|---|
| Water | Carrier | Up to 100 | Up to 1000 L |

Sodium Phenol sulphonate condensate = Phenol Sulfonic Acid Condensation Product, Sodium Salt

INVENTIVE VIII [PCA = Phosphoric acid, decyl octyl ester] Alternative Formulation

| Raw Material | Name | Note | % w/w | | kg / 1000 L | |
|---|---|---|---|---|---|---|
| Pymetrozine (98%) | Pymetrozine | A.I. | 27 | (26.24) | 310 | (305) |
| Flonicamid (97.3%) | Flonicamid | A.I. | 18 | (17.5) | 209 | (203) |
| SAFOL 23E7 | Alcohols, C12-13, branched and linear, | | 0.3 | | 4 | (3.5) |
| | ethoxylated | | | | | |
| Crodafos 810A | Phosphoric acid, decyl octyl ester | PCA | 2 | (1.5) | 18 | (17.5) |
| Sokalan K30 P | polyvinylpyrrolidone | | 1 | | 12 | |
| Agrilan 789(liq) | Acrylic Copolymer with sulfonate group | | 1 | (1.2) | 14 | |
| Tersperse 2218 | Polyethylene glycol mono(tristyrylphenyl) | | 2 | (1.5) | 18 | (17.5) |
| | ether sulfate ammonium salt | | | | | |
| Propylene Glycol | Anti-Freeze | | 5 | | 58 | |
| SAG 1572 | | | 0.2 | | 2 | (2.3) |
| AG RH 23 | Xanthan gum | | 0.1 | (0.06) | 1 | (0.7) |

| | | | | |
|---|---|---|---|---|
| Wancide 520XL | BIT | 0.1 | 1 | (1.2) |

| | | | |
|---|---|---|---|
| Water | Carrier | Up to 100 | Up to 1000 L |

INVENTIVE IX PCA = Phosphoric acid, decyl octyl ester] Alternative Formulation

| Raw Material | Name | Note | % w/w | | kg / 1000 L | |
|---|---|---|---|---|---|---|
| Pymetrozine(98%) | Pymetrozine | A.I. | 27 | (26.24) | 310 | (305) |
| Flonicamid (97.3%) | Flonicamid | A.I. | 18 | (17.5) | 209 | (203) |
| GEROPON CYA/75P | Dioctyl sodium sulfosuccinate | | 0.5 | | 6 | |
| Crodafos 810A | Phosphoric acid, decyl ster | PCA | 2 | (1.7) | 20 | |
| Stearic acid | Stearic acid | | 0.3 | | 4 | (3.5) |
| Synergen 848 | block polyoxyalkylate | | 1.6 | | 19 | |
| Agrilan 789 (liq) | Acrylic Copolymer with sulfonate group | | 1.2 | | 14 | |
| Tersperse 2218 | Polyethylene glycol mono(tristyrylphenyl) | | 1 | | 12 | |
| | ether sulfate ammonium salt | | | | | |
| Propylene Glycol | Propylene Glycol | | 5 | | 58 | |
| SAG 1572 | | | 0.4 | | 5 | |
| AG RH 23 | Xanthan gum | | 0.1 | (0.06) | 1 | (0.7) |

| | | | | |
|---|---|---|---|---|
| Wancide 520XL | BIT | 0.1 | 1 | (1.2) |

| | | | |
|---|---|---|---|
| Water | Carrier | Up to 100 | Up to 1000 L |

INVENTIVE X [PCA = Phosphoric acid, decyl octyl ester] 44% PYM Content

| Raw Material | Name | Note | % w/w | | kg / 1000 L | |
|---|---|---|---|---|---|---|
| Pymetrozine(98%) | Pymetrozine | A.I. | 45 | (44) | 526 | (515) |
| Crodafos 810A | Phosphoric acid, decyl octyl ester | PCA | 3 | (2.9) | 34 | |
| Sokalan K17 | Vinylpyrrolidone | | 1 | (0.9) | 11 | (10.5) |
| Agrilan 700 | Acrylic Copolymer with sulfonate group | | 1 | (1.4) | 16 | (16.4) |
| Tersperse 2218 | Polyethylene glycol mono(tristyrylphenyl) | | 1 | (1.2) | 14 | (14.1) |
| | ether sulfate ammonium salt | | | | | |

| | | | | |
|---|---|---|---|---|
| Propylene Glycol | Anti-Freeze | 6 | (5.8) | 68 |

| SAG 1572 | | 0.4 | 5 | (4.7) |
|---|---|---|---|---|
| AG RH 23 | Xanthan gum | 0.02 | 0.2 | |
| Wancide 520XL | BIT | 0.1 | 1 | (1.2) |

| | | | |
|---|---|---|---|
| Water | Carrier | Up to 100 | Up to 1000 L |

Density = 1.172 g/ml

INVENTIVE XI [PCA = phosphoric acid, decyl octyl ester] Alternative formulation

| Raw Material | Name | | % w/w | | kg / 1000 L | |
|---|---|---|---|---|---|---|
| Pymetrozine (98%) | pymetrozine | A.I. | 27 | (26.24) | 310 | (305) |
| Flonicamid (97.3%) | flonicamid | A.I. | 18 | (17.5) | 209 | (203) |
| Genapol X 080 | ethoxylated C₁₃ oxo alcohol | Wetting | 0.5 | | 6 | (5.9) |
| | | agent | | | | |
| Crodafos 810A | phosphoric acid, decyl octyl ester | PCA | 1.5 | | 18 | (17.7) |
| Stearic acid | stearic acid | | 0.3 | | 4 | (3.5) |
| Sokalan K17 P | vinylpyrrolidone polymer | Dispersant | 0.5 | | 6 | (5.9) |
| Soprophor SC | tristyrylphenol polyoxyethylene ether | Dispersant | 1.5 | | 18 | (17.7) |
| | phosphate amine salt | | | | | |
| Dispersogen 4133 | phosphoric acid ester, sodium salt, aqueous | Dispersant | 1 | | 12 | (11.8) |
| | solution | | | | | |
| Atlox 4913 | methyl methacrylate polymer with | Dispersant | 1.5 | | 18 | (17.7) |
| | methacrylic acid & methoxy | | | | | |
| | polyoxyethylene methacrylate | | | | | |
| Propylene Glycol | propylene glycol | Antifreeze | 5 | (5.3) | 63 | (62.7) |

| Silcolapse C565 | aqueous emulsion of poly organo-siloxanes | Antifoam | 0.4 | 5 | |
|---|---|---|---|---|---|
| AG RH 23 | xanthan gum | Thickener | 0.1 | 1 | (1.2) |
| Wancide 520XL | BIT | Preservative | 0.1 | 1 | (1.2) |

| | | | | |
|---|---|---|---|---|
| Water | Carrier | Carrier | Up to 100 | Up to 1000 L |

INVENTIVE XII [PCA = Phosphoric acid, decyl octyl ester] Alternative Formulation

| Raw Material | Name | Note | % w/w | | kg/1000 L | |
|---|---|---|---|---|---|---|
| Pymetrozine(98%) | pymetrozine | A.I. | 27 | (26.24) | 310 | (305) |
| Flonicamid | flonicamid | A.I. | 18 | (17.5) | 209 | (203) |
| (97.3%) | | | | | | |
| Genapol X 080 | ethoxylated C₁₃ oxo alcohol | Wetting Agent | 0.5 | | 6 | (5.9) |
| Crodafos 810A | phosphoric acid, decyl octyl ester | PCA | 2 | (1.5) | 18 | (17.7) |
| Stearic acid | stearic acid | | 0.3 | | 4 | (3.5) |
| Sokalan K17 P | vinylpyrrolidone polymer | Dispersant | 0.5 | | 6 | (5.9) |
| Agrilan 1015 | fatty alcohol polyoxyethylene | Dispersant | 2.5 | | 30 | (29.6) |
| | polyoxypropylene ether phosphate potassium | | | | | |
| | salt | | | | | |
| Dispersogen 4133 | phosphoric acid ester, sodium salt, aqueous | Dispersant | 1 | | 12 | (11.8) |
| | solution | | | | | |
| Atlox 4913 | methyl methacrylate polymer with methacrylic | Dispersant | 1.5 | | 18 | (17.7) |
| | acid and methoxy polyoxyethylene | | | | | |
| | methacrylate | | | | | |
| Propylene Glycol | Anti-Freeze | Antifreeze | 5 | (5.3) | 63 | (62.7) |

| Silcolapse ® C565 | aqueous emulsion of poly organo-siloxanes | Antifoam | 0.4 | 5 | |
|---|---|---|---|---|---|
| AG RH 23 | xanthan gum | Thickener | 0.1 | 1 | (1.2) |
| Wancide 520XL | BIT | Preservative | 0.1 | 1 | (1.2) |

| | | | | |
|---|---|---|---|---|
| Water | carrier | Carrier | Up to 100 | Up to 1000 L |

INVENTIVE XIII [PCA = Phosphoric acid, decyl octyl ester] Alternative Formulation

| Raw Material | Name | Note | % w/w | | kg / 1000 L | |
|---|---|---|---|---|---|---|
| Pymetrozine(98%) | pymetrozine | A.I. | 27 | (26.24) | 310 | (305) |
| Flonicamid | flonicamid | A.I. | 18 | (17.5) | 209 | (203) |
| (97.3%) | | | | | | |
| Genapol X 080 | ethoxylated c13 oxo alcohol | Wetting agent | 0.5 | | 6 | (5.9) |
| Crodafos 810A | phosphoric acid, decyl octyl ester | PCA | 2 | (1.5) | 18 | (17.7) |
| Stearic acid | stearic acid | | 0.3 | | 4 | (3.5) |
| Dispersogen PL-30 | acrylate block copolymer | | 3 | (2.5) | 30 | (29.5) |
| Synergen 848 | polyethylene- | | 2 | (1.5) | 18 | (17.7) |
| | polypropylene glycol monobutyl ether | | | | | |
| Atlox 4913 | methyl methacrylate polymer with | | 2 | | 24 | (23.6) |
| | methacrylic acid | | | | | |
| | & methoxy polyoxyethylene methacrylate | | | | | |
| Propylene Glycol | Anti-Freeze | | 5 | (5.3) | 63 | (62.7) |

| Silcolapse C565 | aqueous emulsion of poly organo-siloxanes | Antifoam | 0.4 | 5 | |
|---|---|---|---|---|---|
| AG RH 23 | Xanthan gum | Thickener | 0.1 | 1 | (1.2) |
| Wancide 520XL | BIT | Preservative | 0.1 | 1 | (1.2) |

| | | | | |
|---|---|---|---|---|
| Water | Carrier | Carrier | Up to 100 | Up to 1000 L |

A formulation example comprising Pymetrozine: Flonicamid=2:1 Density=1.168

| INGREDIENT | % w/w |
|---|---|
| Pymetrozine Tech | 30 |
| Flonicamid Tech | 15 |
| Lutensol TO-08 | 1 |
| Crodafos 810A | 2 (1.5) |
| Sokalan K17P | 0.5 |
| Pluronic 10500 | 1 |
| Propylene glycol | 5 |
| Tamol DN | 0.5 |
| SAG 1572 | 1 (0.8) |
| Xanthan gum | 0.04 |
| Proxel GXL | 0.01 |
| Water | 45 |
| total | 100 |

### Exemplary Stability Study

### Composition

| Raw Material | Name | Note | % w/w | |
|---|---|---|---|---|
| Pymetrozine tech (98%) | Pymetrozine | A.I. | 31 | (30.6) |
| Flonicamid tech (98%) | Flonicamid | A.I. | 20 | (20.4) |
| Crodafos 810A | C₈ C₁₀ acid phosphate | | 1 | (1.2) |
| CYA/75P | docusate sodium | | 0.3 | |
| Sokalan K30 P | Vinylpyrrolidone homopolymer | | 1 | |
| Agrilan 789 | Polyacrylate copolymer | | 2 | (1.5) |
| Atlox ® 4913 | Polyacrylate comb copolymer | | 3 | (2.5) |

| | | | |
|---|---|---|---|
| Propylene glycol | Anti-Freeze | | 5 |
| SAG 1572 | Anti-Foam | | 0.2 |
| Xanthan gum | Xanthan gum | | 0.04 |
| Wancide 520 XL | 1,2-Benzisothiazol-3(2H)-one | | 0.1 |
| Soft Water | Water | Carrier | up to 100 |

### Stability Testing

| | Results | | |
|---|---|---|---|
| Parameter | Initial T₀ | 14 days @ 54° C. | 7 days @ 0° C. |
| Appearance | Off-white flowable | Off-white flowable | Off-white |
| | suspension | suspension | flowable suspension |
| Pymetrozine Content | 30.4 | 30.3 | 30.4 |
| Flonicamid Content | 20 | 20 | 20 |
| % Pymetrozine Suspensibility | 98.1 | 98.3 | 98.1 |
| (1% dilution) | | | |
| % Flonicamid Suspensibility | 99.9 | 99.8 | 100.7 |
| (1% dilution) | | | |
| pH (neat) | 3.65 | 3.68 | 3.63 |
| Wet sieve test (200 mesh) in % | 100 | 100 | 99 |
| Persistent foam /ml | 35 | 38 | 40 |
| Viscosity (spindle 2, 12 rpm)/ | 1550 | 1500 | 1600 |
| cP | | | |
| Particle size distribution D₉₀ μm | 4.5 | 4.56 | 4.37 |
| Density in g/ml | 1.208 | | |

### Comparative Efficacy Example

A comparison of several Flonicamid Pymetrozine compositions and application protocols as related to efficacy in control of Aphids (Aphis gossypii Glover) on Cotton plants. Applications were by Foliar spray in pot trials, wherein the following Treatments/Compositions are compared, CK=Control Check.

Protocol
Crop: Cotton
Method: Foliar spray, pot trial
Target: Aphid (Aphis gossypil Glover)

| | | | | Al dosage | Water volume | |
|---|---|---|---|---|---|---|
| No. | Treatments | Dosage (ha) | | (g/ha) | L/ha | Application |
| 1 | CK | / | | / | 450 | 1 |
| 2 | ADP1 | 135 | ml | 27 + 40.5 | 450 | 1 |
| 3 | ADP1 | 225 | ml | 45 + 67.5 | 450 | 1 |
| 4 | ADP2 | 135 | ml | 27 + 40.5 | 450 | 1 |
| 5 | ADP2 | 225 | ml | 45 + 67.5 | 450 | 1 |
| 6 | GLL20 | 135 | g | 27 | 450 | 1 |
| | FD25 | 162 | g | 40.5 | | |
| 7 | GLL20 | 225 | g | 45 | 450 | |
| | FD25 | 270 | g | 67.5 | | |
| 8 | RF50 | 225 | g | 45 + 67.5 | 450 | 1 |

ADP1—Flonicamid + Pymetrozine 500SC; Inventive XII (see above)
Recommended application rate: 15-20 mL/667 m² (mu) = (0.225 − 0.3 L/ha)
ADP2—Flonicamid + Pymetrozine 500SC; Inventive XI (see above)
Recommended application rate: 15-20 mL/667 m² (0.225-0.3 L/ha);
GLL20—Commercial Product, Flonicamid 20% SC;
FD25—Commercial Product, Pymetrozine 25% SC;
RF50—Qinkai, Flonicamid + Pymetrozine 50% WG, Henan Yongguangiaodi Agrochem.

### Results

| | | | Number of Aphids (Average) | | | | | |
|---|---|---|---|---|---|---|---|---|
| # | Treatment | AI g/Ha | 0 DAA | 1 DAA | 3 DAA | 7 DAA | 14 DAA | 21 DAA |
| 1 | CK (control) | / | 181.5 | 216.5 | 301.5 | 1093.75 | 890 | 1118 |
| 2 | ADP1 | 27 + 40.5 | 182.25 | 170.75 | 126.75 | 1.5 | 81.75 | 502.25 |
| 3 | ADP1 | 45 + 67.5 | 181.75 | 113.75 | 85.25 | 1.25 | 97.25 | 599 |
| 4 | ADP2 | 27 + 40.5 | 169.25 | 106.25 | 80.25 | 0.75 | 44 | 235.75 |
| 5 | ADP2 | 45 + 67.5 | 172 | 96.5 | 68 | 0.75 | 100.25 | 360 |
| 6 | GLL20 | 27 | 200 | 135.5 | 103.5 | 1.5 | 132 | 345 |
| | FD25 | 40.5 | | | | | | |
| 7 | GLL20 | 45 | 185.25 | 130.75 | 48.25 | 2 | 198.25 | 350.75 |
| | FD25 | 67.5 | | | | | | |
| 8 | RF50 | 45 + 67.5 | 212.25 | 167.75 | 89.25 | 0.75 | 145.75 | 338 |

### Comparison of Efficacy

| | | | % EFFICACY | | | | |
|---|---|---|---|---|---|---|---|
| # | Treatment | AI g/Ha | 1 DAA | 3 DAA | 7 DAA | 14 DAA | 21 DAA |
| 1 | CK (control) | / | 0 | 0 | 0 | 0 | 0 |
| 2 | ADP1 | 27 + 40.5 | 21.44 | 58.13 | 99.86 | 90.85 | 55.26 |
| 3 | ADP1 | 45 + 67.5 | 47.12 | 71.76 | 99.89 | 89.09 | 46.50 |
| 4 | ADP2 | 27 + 40.5 | 47.26 | 71.46 | 99.93 | 94.70 | 77.39 |
| 5 | ADP2 | 45 + 67.5 | 52.81 | 76.2 | 99.93 | 88.11 | 66.02 |
| 6 | GLL20 | 27 | 43.44 | 68.85 | 99.88 | 86.54 | 72 |
| | FD25 | 40.5 | | | | | |
| 7 | GLL20 | 45 | 40.02 | 84.32 | 99.82 | 78.18 | 69.26 |
| | FD25 | 67.5 | | | | | |
| 8 | RF50 | 45 + 67.5 | 33.96 | 74.69 | 99.94 | 86.00 | 74.15 |

All tested treatments display comparable full efficacy at 7 days after application, but the inventive compositions act faster.

The inventive compositions improved persistence of between 10 to 14 days.

Even at low dosage 67.5 g/Ha (27+40.5), ADP2 [Inventive XI] has a similar performance as the tank-mix of commercial solo compositions GLL20 plus FD25 but acts faster when measured 1 day after application.

At recommended dosage 112.5 g ai/ha (45+67.5), both ADP1[Inventive XII], and ADP2 [Inventive XI], act faster than the tank-mix of GLL20 plus FD25.

1. A combination comprising,
a. pymetrozine,
b. pymetrozine compatibilizing agent (PCA), and
c. water,
wherein the pymetrozine compatibilizing agent is selected from one or more of,
i. phosphoric acid diester, of the following structure, 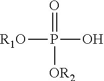
wherein R₁ and R₂ are each independently alkyl or aryl, and R₁ and R₂ are either the same or different;
ii. phosphoric acid mono ester, of the following structure, 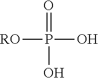
wherein R is alkyl or aryl;
iii. Sulfuric acid mono ester, of the following structure, 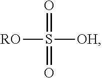
wherein R is alkyl or aryl;
iv. Sulfonic acid, of the following structure, 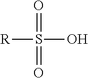
wherein R is alkyl or aryl, and
v. any and all combinations thereof,
characterized in that said alkyl groups comprise at least 6 carbon atoms.

2. A combination comprising
a. pymetrozine,
b. pymetrozine compatibilizing agent (PCA) and
c. water,
wherein the pymetrozine compatibilizing agent is selected from one or more of, monoalkyl phosphate; dialkyl phosphate; a dialkyl ester of sulfonated succinic acid and any and all combinations thereof, characterized in that said alkyl groups comprise at least 6 carbon atoms.

3. The combination of any one of claims 1 and 2, wherein the pymetrozine compatibilizing agent (PCA) is selected from the group of,
phosphoric acid di-(C₆-C₂₂) alkyl ester;
phosphoric acid, n-octyl, n-decyl esters (C₈, C₁₀);
Iso-tridecyl phosphate (C₁₃, C₁3);
di-iso-octyl phosphate (C₈, C₈);
di-decyl phosphate (C₁₀, C₁₀);
dioctyl sodium sulfosuccinate (acidified); and
combinations of two or more thereof.

4. A flowable water-based pymetrozine composition comprising the combination as claimed in any one of claims 1-3.

5. The composition of claim 4 wherein the water-based pymetrozine composition is an aqueous suspension concentrate comprising from 10%±10% (about 10%) to 55%±10% (about 55%), w/w particulate pymetrozine based on the total weight of the composition as solid pymetrozine particles.

6. The composition as claimed in any one of claims 4 and 5, comprising a fatty acid.

7. The composition as claimed in any one of claims 4-6, comprising stearic acid.

8. The aqueous suspension concentrate as claimed in claim 5 comprising particulate pymetrozine and a fatty acid such as stearic acid, diluted with additional water.

9. The aqueous suspension concentrate as claimed in claim 8 comprising stearic acid, wherein one part of the aqueous suspension concentrate of claim 5 is diluted with between about 96 to 99.95 parts of additional water.

10. The combination of any one of claims 1-3 or the composition of any one of claims 4-9 comprising at least one additive that can shield the pymetrozine from, or lessen the impact of exposure to sunlight characterized in that the half-life of pymetrozine in said combination or composition on exposure to sunlight is selected from the group of,
a. at least 24 hours;
b. in excess of 96 hours; and
c. greater than 1 week.

11. The combination or the composition of claim 10, wherein the additive that can shield the pymetrozine from, or lessen the impact of exposure to sunlight is selected from by any, some, or all of, light stabilizers, UV absorbers, radical scavengers, neutralizers, and antioxidants.

12. The combination of any one of claims 1-3 or the composition of any one of claims 4-11 characterized by a pH below 5 wherein said pymetrozine is stable to the extent that no more than 5% by weight of said pymetrozine is degraded after storage at 54° C. for 2 weeks.

13. The combination of any one of claims 1-3 or the composition of any one of claims 4-12 characterized by a pH between 3 and 4 wherein said pymetrozine is stable to the extent that no more than 1% by weight of said pymetrozine is degraded after storage at 54° C. for 14 days.

14. The combination of any one of claims 1-3 or the composition of any one of claims 4-12 comprising at least one additive that can, maintain the stability of the pymetrozine characterized by no more than 5% pymetrozine degradation after periods of storage, at elevated temperatures exemplified by storage at 54° C. over 14 days, as compared to the pymetrozine content of the composition at the start of said storage period, wherein said additive is selected from acid, base, buffer, polyvinylpyrrolidone and/or vinylpyrrolidone homopolymer, light stabilizers, UV absorbers, radical scavengers, neutralizers, and antioxidants.

15. The combination or composition of claim 14 characterized by no more than 1% pymetrozine degradation after storage at 54° C. over 14 days, as compared to the pymetrozine content of the composition at the start of said storage period.

16. The combination of any one of claims 1-3 or the composition of any one of claims 4-15 comprising at least one additive that can, prevent and/or inhibit any of, crystallization, recrystallization, or interconversion of pymetrozine solid forms.

17. The combination or composition of claim 16 wherein said additive is a Crystal Poisoner or crystallization inhibitor.

18. The combination of any one of claims 1-3 or the composition of any one of claims 4-17 wherein the pymetrozine is an anhydrate.

19. The combination of any one of claims 1-3 or the composition of any one of claims 4-17 wherein the pymetrozine is hydrated.

20. The combination of any one of claims 1-3 or the composition of any one of claims 4-19 wherein the weight ratio between the pymetrozine and water in the combination or the composition is selected from the group of, between 1:6±10% to 1:0.7±10% (about 1:6 to about 1:0.7); and 0.63±10% (about 0.63).

21. The combination of any one of claims 1-3 or the composition of any one of claims 4-20 wherein the % concentration w/w of the pymetrozine in the combination or composition is selected from the group of,
a. greater than about 20%;
b. 27%±10% (about 27%);
c. 30%±10% (about 30%);
d. 44%±10% (about 44%);
e. 55%±10% (about 55%);
f. 50%±10% (about 50%) or more;
g. from 10%±10% to 55%±10% (from about 10% to about 55%);
based on the total weight of the composition.

22. The combination of any one of claims 1-3 or the composition of any one of claims 4-21 wherein the % concentration w/w of the water content in the combination or composition is selected from the group of,
a. about 75% (75%±10%), or less;
b. about 70% (70%±10%), or less;
c. about 50% (50%±10%), or less;
d. 42%±10% (about 42%);
based on the total weight of the composition.

23. The combination of any one of claims 1-3 or the composition of any one of claims 4-22 wherein the weight ratio between the pymetrozine compatibilizing agent and the pymetrozine is selected from the group of,
a. from 1:5±10% to 1:40±10% (about 1:5 to about 1:40);
b. from 1:8±10% to 1:25±10% (about 1:8 to about 1:25);
c. from 1:13±10% to 1:22±10%; (about 1:13 to about 1:22);
d. from 1:15±10% to 1:22±10% (about 1:15 to about 1:22);
e. about 1:27 to about 1.2:26.2;
f. about 1.5:27 to about 1.5:26.2;
g. about 18:305 to about 17.5:310;
h. about 1.4:27 to about 1.4:26.2;
i. about 16:305 to about 16:310;
j. about 2.5:27 to about 2.5:26.2;
k. about 29:305 to about 29:310.
l. about 1.7:27 to about 1.7:26.2;
m. about 20:305 to about 20:310;
n. about 2.9:45 to about 2.9:44); and
o. about 34:526 to about 34:515.

24. The combination of any one of claims 1-3 or the composition of any one of claims 4-23 wherein the pymetrozine compatibilizing agent is selected from the group of,
a. phosphoric acid di-alkyl ester;
b. phosphoric acid, n-octyl, n-decyl esters;
c. iso-tridecyl phosphate;
d. tridecyl phosphate;
e. di-iso-octyl phosphate;
f. di-decyl phosphate;
g. dioctyl sodium sulfosuccinate (acidified); and
h. any and all combinations thereof.

25. The combination of any one of claims 1-3 or the composition of any one of claims 4-24 wherein the pymetrozine compatibilizing agent is phosphoric acid di-alkyl ester wherein the % concentration w/w of the phosphoric acid di alkyl ester, is selected from the group of,
a. about 0.5% or more;
b. about 1% or more; and
c. from about 1% to 5%±10% (about 5%),
by weight based on the total weight of the combination or composition.

26. The combination of any one of claims 1-3 or the composition of any one of claims 4-25 wherein the combination or composition comprises an insecticide exemplified by compounds selected from the group of, flonicamid, pyridaben, imicyafos, thiacloprid, ethiprole, ethion, thiamethoxam, imidacloprid, fenoxycarb, mobucin, nitenpyram, abamectin, buprofezin, pyriproxyfen, etofenprox or acetamiprid.

27. The combination of any one of claims 1-3 or the composition of any one of claims 4-26 which comprises an aqueous suspension of solid particulate pymetrozine and flonicamid and wherein the pymetrozine compatibilizing agent is in acid form selected from the group of,
a. phosphoric acid di-(C₆-C₂₂) alkyl ester;
b. phosphoric acid, n-octyl, n-decyl esters;
c. iso-tridecyl phosphate;
d. tridecyl phosphate;
e. di-iso-octyl phosphate;
f. di-decyl phosphate;
g. dioctyl sodium sulfosuccinate (acidified); and
any and all combinations thereof, wherein said combination or composition comprises one or more additives selected from, polycarboxylate with C₈, sulfonate groups, modified; polycarboxylate with benzyl sulfonate group, modified; butanol derived EO/PO copolymer; polyethylene glycol mono(tristyrylphenyl) ether sulfate, ammonium salt; Polyacrylate comb copolymer; Sodium Phenol sulphonate condensate; ethylene oxide propylene oxide copolymer; polyethylene glycol tristyrylphenyl ether phosphate salt, such as triethanolamine salt; poly(ethylene glycol-co-propylene glycol) phosphoric acid ester salt such as, sodium salt;
acrylate block copolymer;
and polyvinylpyrrolidone.

28. The combination of any one of claims 1-3 or the composition of any one of claims 4-27 wherein the combination or composition comprises one or more additives selected from, polycarboxylate with C₈, sulfonate group, modified; polycarboxylate with benzyl sulfonate group, modified; butanol derived EO/PO copolymer; polyethylene glycol mono(tristyrylphenyl) ether sulfate, ammonium salt; Polyacrylate comb copolymer; Sodium Phenol sulphonate condensate; ethylene oxide propylene oxide copolymer; polyethylene glycol tristyrylphenyl ether phosphate salt, such as triethanolamine salt; poly(ethylene glycol-co-propylene glycol) phosphoric acid ester salt such as, sodium salt; acrylate block copolymer and polyvinylpyrrolidone.

29. The combination or the composition of any one of claims 26, 27, or 28 comprising flonicamid, wherein the weight ratio between the pymetrozine and the flonicamid in the combination or the composition is selected from the group of, from 1:2 to 6:1; and
from 2:1 to 3:2.

30. The combination or the composition of any one of claims 26-29 which comprises an aqueous suspension of solid particulate pymetrozine and flonicamid and wherein the pymetrozine compatibilizing agent is selected from the group of, phosphoric acid di-(C₆-C₂₂) alkyl ester; and
phosphoric acid, n-octyl, n-decyl esters.

31. A packaged aqueous suspension concentrate composition comprising an aqueous suspension of solid particulate pymetrozine and a compound selected from one or more of,
a. mono-alkyl phosphate;
b. di-alkyl phosphate;
c. di-alkyl ester of sulfonated succinic acid; and
d. any and all combinations thereof,
wherein each of compounds a., b., and c. is characterized in that said alkyl groups comprise at least 6 carbon atoms, and the aqueous suspension concentrate composition has a pH of about 4 or less, wherein the pymetrozine in the aqueous suspension concentrate composition is characterized by a half-life when exposed to sunlight selected from the group of,
i. about 24 hours or more;
ii. about 96 hours or more; and
iii. about a week or more.

32. The packaged aqueous suspension concentrate composition as claimed in claim 31 comprising a compound selected from one or more of, light stabilizers, UV absorbers, radical scavengers antioxidant; and combinations of two or more thereof.

33. The packaged aqueous suspension concentrate composition as claimed in claim 31 comprising flonicamid.

34. The packaged aqueous suspension concentrate composition as claimed in claim 31 comprising stearic acid.

35. A packaged physically stable, agricultural aqueous suspension concentrate composition comprising an aqueous suspension of solid particulate pymetrozine and a compound selected from one or more of,
a. mono-alkyl phosphate;
b. di-alkyl phosphate;
c. di-alkyl ester of sulfonated succinic acid; and
d. any and all combinations thereof,
wherein each of compounds a., b., and c. is characterized in that said alkyl groups comprise at least 6 carbon atoms, and the aqueous suspension concentrate composition has a pH of about 4 or less, wherein the aqueous suspension concentrate composition is characterized by being physically stable after it is stored for a period of storage selected from,
i. 2 weeks prior to application;
ii. 1 month prior to application;
iii. 2 months prior to application;
iv. 3 months prior to application;
v. 6 months prior to application; and
vi. 2 weeks after storage at 54° C.,
characterized in that the physical stability is one, some or all of, flowability stability, viscosity stability, and solid form conversion stability.

36. The packaged aqueous suspension concentrate composition as claimed in claim 35 comprising flonicamid.

37. The packaged aqueous suspension concentrate composition as claimed in claim 35 comprising a crystallization inhibitor and/or a crystal poisoner.

38. A method for controlling an unwanted or harmful insect pest or controlling a plant disease caused by an unwanted insect comprising applying an effective amount of the combination of any one of claims 1-3 and/or the composition of any one of claims 4-27 to a plant, a locus thereof, propagation material thereof, or an area infested with the unwanted or harmful insects so as to thereby control the unwanted insects or control the plant disease caused by the harmful or unwanted insect.

39. The method of claim 38 wherein controlling an unwanted or harmful insect pest is the selective control of plant-sap-sucking Hemipteran and Homopteran insects including aphids, whiteflies and planthoppers while leaving other invertebrates unharmed.

40. A method for improving the percentage efficacy rate for control of an aphid pest measured at one single day after application of a diluted pymetrozine aqueous suspension concentrate composition, the method comprising applying a diluted effective amount of the concentrate composition as claimed in any one of claims 33 or 36 to a plant, a locus thereof, propagation material thereof, or an area infested with the aphids so as to thereby improve the percentage efficacy rate control of the aphids one day after application, wherein the diluted effective amount of the concentrate composition is obtained by removing the aqueous suspension concentrate composition from package and diluting prior to application.

41. The method of claim 40 wherein the pymetrozine aqueous suspension concentrate comprises pymetrozine, flonicamid, phosphoric acid decyl octyl ester, stearic acid and water.

42. The method as claimed in any one of claim 38-41 wherein the combination or composition is characterized by improved persistence such as from about 10 to about 14 days.
